(19) United States
(12) Patent Application Publication
(10) Pub. No.: US 2014/0180896 A1
(43) Pub. Date: Jun. 26, 2014

(54) SYSTEM FOR IMPLEMENTING A CENTRAL BANK CURRENCY TRADING RIGHTS MANAGEMENT PROCESS OVER A DISTRIBUTED COMMUNICATIONS NETWORK DEPLOYED IN A FINANCIAL MARKETPLACE

(71) Applicant: Joseph H. Hardison, Darien, CT (US)

(72) Inventor: Joseph H. Hardison, Darien, CT (US)

(73) Assignee: INTEREST CAPTURING SYSTEMS, LLC, Darien, CT (US)

(21) Appl. No.: 14/082,134

(22) Filed: Nov. 16, 2013

Related U.S. Application Data
(63) Continuation-in-part of application No. 13/627,146, filed on Sep. 26, 2012.
Application No. 13/627,146 is a continuation-in-part of application No. 13/492,886, filed on Jun. 10, 2012, now Pat. No. 8,589,261.

(51) Int. Cl. G06Q 40/04

(52) U.S. Cl. CPC G06Q 40/04
USPC 705/37

(57) ABSTRACT

A computer-network implemented system recognizes that a central bank retains the right to lend a currency or the currency trading ownership right prior to the issuance/sale of a currency, or to restructure its currency to recapture and withhold the right to lend or trade its currency. The system allows currency borrowers/purchasers to request the right to lease or purchase the non-borrowable currency from the central bank, according to prices and time periods set by the central bank. The currency borrowers/short-sellers or purchasers can acquire the right to lend or trade the non-borrowable currency so as to purchase the non-purchasable currency from the central bank. Thereafter, currency borrowers/short-sellers and currency purchasers can sell the non-borrowable currency short or purchase the non-purchasable currency in the marketplace and profit from a short sale of the currency or from owning the currency, without adversely effecting the central bank's, or its country's economy.

### RELATED CASES

The present Application is a Continuation-in-Part of co-pending application Ser. No. 13/627,146 filed Sep. 26, 2012 entitled “SYSTEM FOR IMPLEMENTING A COMMODITY ISSUER RIGHTS MANAGEMENT PROCESS OVER A DISTRIBUTED COMMUNICATIONS NETWORK DEPLOYED IN A FINANCIAL MARKETPLACE”; and co-pending application Ser. No. 13/492,886 filed Jun. 10, 2012 entitled “SYSTEM FOR IMPLEMENTING A SECURITY ISSUER RIGHTS MANAGEMENT PROCESS OVER A DISTRIBUTED COMMUNICATIONS NETWORK DEPLOYED IN A FINANCIAL MARKETPLACE”, which is a Continuation of application Ser. No. 12/465,135 filed Jun. 11, 2009 entitled “SYSTEM FOR IMPLEMENTING A SECURITY ISSUER RIGHTS MANAGEMENT PROCESS OVER A DISTRIBUTED COMMUNICATIONS NETWORK DEPLOYED IN A FINANCIAL MARKETPLACE”, now U.S. Pat. No. 8,255,296 and commonly owned by Interest Capturing Systems, LLC, and incorporated herein by reference as if set forth in its entirety.

### BACKGROUND OF INVENTION

1. Technical Field

The present invention relates to a method of, and system for, enabling central banks to exercise the rights they possess as the initial owners/producers of currencies in order to manage and optimize the utility and value of their offerings and holdings in the global financial marketplace.

2. Brief Description of the Prior Art

In conventional currency trading, as set forth in FIG. 1 of the Drawings, central banks first produce currencies—examples would include the U.S. Dollar, the Japanese Yen, the European Currency Union's Euro, the Canadian Dollar, the Chinese Yuan, and all other currencies—and then, ultimately, offer those currencies in the global financial market, where the currencies are bought or borrowed and then traded, thus completing the currency cycle for the central bank. In the currency markets, central banks and other market participants may enlist various derivative hedging strategies to protect against volatility in the price of the currency relative to other currencies or assets.

However, once a currency has been issued into the global financial marketplace, a central bank loses most control over its currency, although it can adjust interest rates and offer debt securities to help adjust the value of its currency but, outside of those options, it basically has no other means by which to combat excessive currency speculation. Other market participants may benefit from driving the price of the central bank's currency lower or higher, and other factors like weather, natural disasters, international conflicts, other countries' financial problems, organized labor strikes and other actions and events may also have a detrimental impact on a currency's value post-issuance, which can damage a country's (or currency bloc's) economy and impair the goals of the central bank that issued the currency.

A central bank may utilize various derivative contracts and monetary policy strategies to help protect against future currency depreciations/appreciations caused by market participants or by the aforementioned other factors, but these can be expensive and can leave a central bank exposed to financial loss if these contracts move against the central bank or if the monetary policy is flawed.

One of the problems that central banks encounter is that of short-selling of their currencies, through which, investors and speculators either borrow a currency through other market participants and/or financial institutions, often through the use of futures contracts or through other derivative financial instruments, and sell it short in the market hoping to buy it back at a lower price and make a profit. Short-selling is also employed by speculators (hedge funds, bank trading desks, individuals, etc.) to make a direct bet against the price of a currency.

These short sales are often highly-leveraged, and short-selling puts downward pressure on a currency, which can have several harmful effects including capital flight and inflation. Also, as the price of the currency falls, it can force other holders to sell the currency at disadvantageous prices in order to avoid additional losses if the currency continues to fall in price, which then adds to the selling pressure on the currency and drives its price lower. Lower currency prices, depending on the nature of the country's economy, may help or hurt the country's economy. As central banks often rely on borrowing to fund their operations, lower currency prices can, in extreme circumstances, lead to extreme financial distress for central banks and to currency devaluations.

However, currency short-selling has several useful functions. It allows central banks to let the market adjust its monetary policy and a weaker currency can help address deflation and trade imbalance issues. The most obvious benefit short selling/weakening of a currency presents is that it makes a country's export economy more competitive vis-à-vis other countries with stronger currencies.

Another problem that central banks encounter is that of speculators and other market participants driving their currencies too high through outright purchases of their currency, purchases of their currency futures or purchases of other derivative financial instruments linked to their currencies. Appreciating currencies can harm a country's export economy (goods become too expensive) and can wreak havoc with a country's monetary policy.

The advent of more sophisticated derivatives instruments, currency-based, highly-levered exchange-traded funds (ETF's) and other exotic derivatives, along with the proliferation of hedge funds and other speculative interests, have combined to allow speculators and hedgers to put undue and intentional selling and buying pressure on currencies. The most famous example of this is hedge fund operator George Soros's bet against the British Pound who, along with other hedge funds and speculators, forced a devaluation of the pound in 1992.

Another problem, alluded to earlier, is that the further the price of a currency is depressed by short-selling, the harder, more expensive, and more dilutive it becomes for a central bank to control the value of its currency, and a loss of control of a currency can wreak havoc on a country's economy. Excessive selling pressure and the resulting lower currency price, via short sales and derivative instruments, can influence and/or cause rating agencies to downgrade a country's financial ratings, thereby increasing the cost of raising additional capital via sovereign debt sales. In extreme cases, the pressure on a country's currency from leveraged speculation can make it virtually impossible to raise new capital to fund a government via sovereign debt sales due to a lack of demand for the country's debt in the face of currency level uncertainty.

When a country's/central bank's currency comes under speculative attack, the country has several options with which it can try to defend its currency. It can raise or lower interest rates to attract currency purchases or to discourage them, it can spend its currency reserves to buy its own currency in an effort to defend its value and/or it can sell its currency in the global foreign exchange market in an effort to weaken it. In extreme cases, a country, usually through its central bank, can get help in the form of other countries' central banks buying or selling its currency. Taxes on foreign exchange trading have even been proposed to discourage this damaging speculation that leads to appreciating or depreciating currencies. Unfortunately, these remedies have proven to be temporary fixes at best and, in many cases, have failed to work at all. A central bank can raise or lower interest rates to make it more expensive or cheaper to borrow/short or to buy its currency, and it can buy or sell its own currency by intervening in the foreign exchange market, but these measures hurt the country's overall economy, and other countries are loathe to waste a lot of their foreign exchange reserves to help out another country. When these measures fail to stem the currency's decline or appreciation, capital flight or inflow often ensues further hurting the country's economy.

Recently, to confront excessive speculation in currencies, some central banks and countries have been espousing a financial transaction tax, whereby all trades in a country's currency (or other financial instruments) would incur a tax, usually based on the volume of the transaction. While a financial transaction tax helps a central bank/country reduce speculation against its currency, it has other deleterious effects. A financial transaction tax punishes those that are buying or selling the central bank's currency in the direction the central bank would like the currency to go, and countries that impose special taxes discourage investment causing capital to flee or to avoid the country.

As has been demonstrated above, excessive short-selling or excessive buying in currencies is an ongoing problem in today's capital markets, as it can have a detrimental impact on currency prices and, thus, on countries' economies. Short selling can increase volatility in a currency's price, which can force central banks to intervene to buy their currency to support it and stabilize their country's economy, often hurting their economy and financial stability in the process. Excessive buying of a country's currency can have similar deleterious effects. Every proposal to address the problems associated with currency speculation, to date, has been regulatory in nature, including currency trading bands, currency trading taxes, and currency position limits. What is needed is a market-based solution that allows central banks to manage, and to benefit from, short-selling and buying of their currencies.

Also known in the prior art is the ability of market practitioners to unbundle various sets of rights associated with issued securities in order to derive added benefit from the individual rights associated with issued securities (equity and debt). As an example, a hedge fund may purchase a large block of stock in a company in order to exercise the voting rights associated with those shares for/against management's proposals and, at the same time, buy downside derivative protection in the form of equity put options (or other equity derivatives) on those shares to hedge against any downside move in the stock. This strategy has effectively allowed the hedge fund to gain control of a voting interest (voting rights) in the company without economic exposure should the stock it is holding move lower (in fact, the hedge fund can gain the voting interest (voting rights) and profit if the stock moves lower via this arrangement).

Similarly, an investor may hold an equity or debt security and pledge the income stream (right to dividend payments (equity) or right coupon payments (debt)) toward a charity, educational entity or trust. Effectively, the investor has unbundled an equity or debt right from the sets of rights that accompany issued equity and/or debt.

U.S. Publication No. 20050125323 to Warren, U.S. Publication No. 20020198833 to Wohlstadter, U.S. Publication No. 20050080705 to Chaganti, and U.S. Pat. No. 7,310,616 to Sugahara all disclose various methods for recognizing and trading various security rights of issued securities. However, each of these prior art references fails to address, either singularly or in combination with each other, the aforementioned problems associated with short-selling of an owner's/producer's commodity, as each addresses an issued security instrument, not a commodity, and still allows a company's or government's issued securities to be shorted—a process over which, the company or government has no control.

In view of all of the aforementioned shortcomings, deficiencies and inefficiencies that exist in the financial/currency marketplaces, there is a great need in the art for improved systems and methods for solving the problem(s) associated with investors, speculators and/or hedgers putting unwarranted downward or upward pressure on the prices of countries'/central bank's currencies through excessive short sales or excessive purchases and the use of highly-leveraged derivative instruments, while avoiding the shortcomings and drawbacks of the prior art apparatus and methodologies heretofore known.

### OBJECTS AND SUMMARY OF THE PRESENT INVENTION

Accordingly, it is a primary object of the present invention to provide a method of, and system for, solving the inefficiencies of the prior art, detrimental currency trading and speculation methods, while avoiding the shortcomings and drawbacks of the prior art apparatus and methodologies.

Another object of the present invention is to provide a method and system which inherently recognize the separate, withholdable, and transferable rights associated with currencies, thereby enabling the maximization of economic value that such property can support within the marketplace.

Another object of the present invention is to provide such a method and system, wherein the currency trading rights associated with an individual currency are automatically unbundled (i.e. individually separated) in such form that each individual right, or subsets of individual rights, can be withheld prior sale into a currency market and then transferred, temporarily or permanently, independently of the other currency trading rights in an effort to optimize the utility and economic value to the country/central bank.

Another object of the present invention is to provide such a method and system wherein central banks, as stewards of their countries' currencies, are afforded the opportunity to freely withhold and transfer certain of the currency trading rights they possess in order to limit certain other activities they may deem detrimental to their national economic interests.

Another object of the present invention is to provide central banks with the ability to prevent speculators and other non-investing entities from selling short excessively their currencies by allowing the central banks to withhold the currency trading right to lend their currencies (FXR (ζ, $)) in order to prevent their currency from being borrowed by short-sellers to drive it lower through selling it short.

Another object of the present invention is to provide central banks with the ability to prevent speculators and other non-investing entities from purchasing their currencies excessively by allowing the central banks to withhold the currency trading ownership right to their currencies (FXR (α, $)) in order to prevent their currency from being excessively purchased by speculators or other investors in an attempt to drive it higher.

Another object of the present invention is to allow a central bank to establish a band in which it is comfortable to have its currency trade vs. another currency and, in which, the central bank does not charge a lease rate or sale price to borrow its currency to sell short or to purchase its currency to go long its currency; outside of the established band, the central bank may charge both short sellers or purchasers of its currency.

Another object of the present invention is to provide central banks with the ability to prevent investors, speculators and others from using the central banks' currencies as collateral for borrowing, or other trading and investing activities, by allowing the central banks to withhold the currency trading right to post those currencies as collateral (FXR (η, $)) in order to prevent them from being used as collateral for borrowing, trading or investing.

Another object of the present invention is to provide such a method and system, wherein the set of currency trading rights associated with a currency {FXR (α . . . η, $)} possessed by a country/central bank are separate and divisible.

Another object of the present invention is to provide such a method and system, wherein the set of currency trading rights associated with a currency {FXR (α . . . η, $)} can be utilized in non-mutually exclusive manners.

Another object of the present invention is to allow central banks to establish pricing for the withheld currency trading right to lend (FXR (ζ, $)) their currency in order to optimize income associated with leasing or selling the withheld currency trading right to lend their currency, for the benefit of the central banks

Another object of the present invention is to allow central banks to establish pricing for the withheld currency trading ownership right (FXR (α, $)) their currency in order to optimize income associated with leasing or selling the withheld currency trading ownership right to their currency, for the benefit of the central banks

Another object of the present invention is to allow central banks to determine how much, if any, of their withheld currency trading right(s) to lend their currency or to own their currency they will lease or sell in order to control short-selling/excessive buying of their currency and to profit from any short-selling/excessive buying of their currency.

Another object of the present invention is to provide an Internet-based method and system, wherein all participating central banks feed all currency trading rights information (withheld rights, leased rights, transferred rights, etc.) directly into a database maintained by the system of the invention, for the purpose of allowing the Internet-based system to catalogue and display certain currency trading rights information to the central banks

Another object of the present invention is to provide such an Internet-based method and system, wherein a process is provided to allow the system to rank various currency trading rights for a system user's benefit via criteria that may differ vastly from that typically employed by a system user.

Another object of the present invention is to provide such an Internet-based method and system, whereby institutional users are provided with a manual and/or automatic means for accessing the universe of currency trading rights details (details on individual currency's rights withholdings, leasing, transfers, etc.), thereby ensuring that they fulfill their fiduciary duty to their investors who seek the various qualities/currency trading rights in the currencies they purchase, sell and hold.

Another object of the present invention is to provide such an Internet-based method and system, wherein financial institutions and any entity holding a fiduciary responsibility have the ability to fulfill their obligations to their investors by seeking the best currency trading rights terms, thereby reducing potential legal liability associated with the failure to fulfill attendant fiduciary responsibilities and obligations.

Another object of the present invention is to provide such an Internet-based method and system, wherein a system user would still be able to establish one or more important criteria regarding various currencies' trading rights and then allow the system to take over and make investment decisions based on the limited criteria provided by a system user.

Another object of the present invention is to provide an Internet-based method and system, wherein central banks are able to exact higher remuneration from banks, financial institutions, investors and speculators for currency trading rights withheld, mainly the right to lend and the right to own (ownership) the central banks' currencies.

Another object of the present invention is to provide an Internet-based method and system, wherein relational databases automatically receive currency pricing information from various currency brokers, banks, and other financial institutions for the central banks' currencies and display the information based on absolute rank and, separately, on the system user's and on the system's preferences.

Another object of the present invention is to provide such an Internet-based method and system, wherein government regulatory agencies can actively monitor all currency trading right(s) withholdings, transfers, sales, leases, and other related transactions.

Another object of the present invention is to provide an Internet-based method and system for representing and accounting for the currency trading rights held by central banks, and the transfers of such rights among a network of financial institutions, provided by the Internet-based system and method of the present invention.

Another object of the present invention is to provide a transparent “netting” process through which central banks, financial institutions, and investors settle withheld/transferred/leased currency trading rights amongst themselves.

Another object of the present invention is to provide central banks, with currency already trading in the global financial marketplace, with the ability to convert those existing currencies in order to withhold the currency trading right(s) to lend their currencies to preclude short-selling of those currencies already trading in the global financial marketplace or to withhold the currency trading right(s) to own their currencies in order to preclude excessive buying of those currencies already trading in the global financial marketplace. This will allow central banks to preclude behavior they deem detrimental to their own interests.

Another object of the present invention is to provide central banks with the ability to market various withheld and/or unbundled currency trading rights (principally, the currency trading rights to lend and/or to own a currency) in order to control and profit from the unlocked value of those rights.

Another object of the present invention is to provide central banks with the ability to classify their currencies, of all types, with certain alphanumeric-coded designations to signify that certain currencies cannot be lent, used as collateral, sold, or used in any other way that may contravene the central banks' original, included currency trading specifications based on the central banks' established currency trading rights packages.

Another object of the present invention is to provide various schedules upon which central banks can collect currency trading right lending or currency trading ownership right income based on production cycles, average length of futures contracts, set time periods, or other metrics, as currency trading time periods vary greatly; some schedules may be short-term to reflect speculation, while some schedules may be much longer in tenure to reflect long-term investments.

Another object of the present invention is to allow central banks to establish various currency trading rights lease or sale income sharing agreements based on which country is being hurt economically by its currency's excessive appreciation or excessive depreciation.

These and other objects of the present invention will become more apparent from the descriptions and drawings contained herein, and are, by no means, confined or limited by other improvements or advantages that may be realized.

### BRIEF DESCRIPTION OF THE DRAWINGS

In order to understand more fully the Objects of the Invention, the following Detailed Description of the Illustrative Embodiments should be read in conjunction with the appended figure drawings, wherein:

FIG. 1 is a schematic representation illustrating the flow of global currency trading, wherein central banks oversee their currencies, through a variety own means, while their currencies flow throughout the global financial markets where they are used for trade amongst countries, investments in various countries' markets, and for speculation. These global currency flows are overseen by the central banks and national and international regulators, with the international regulators being comprised of officials from various central banks and other governments' regulatory agencies. Once a central bank introduces its currency into the global foreign exchange market, various users, investors and speculators purchase and sell the currency either for trade, investment or speculation, with speculators hoping to profit from movements, up and down, in the currency's price;

FIG. 2 is a schematic representation of the various rights traditionally possessed by owners and/or holders of currencies;

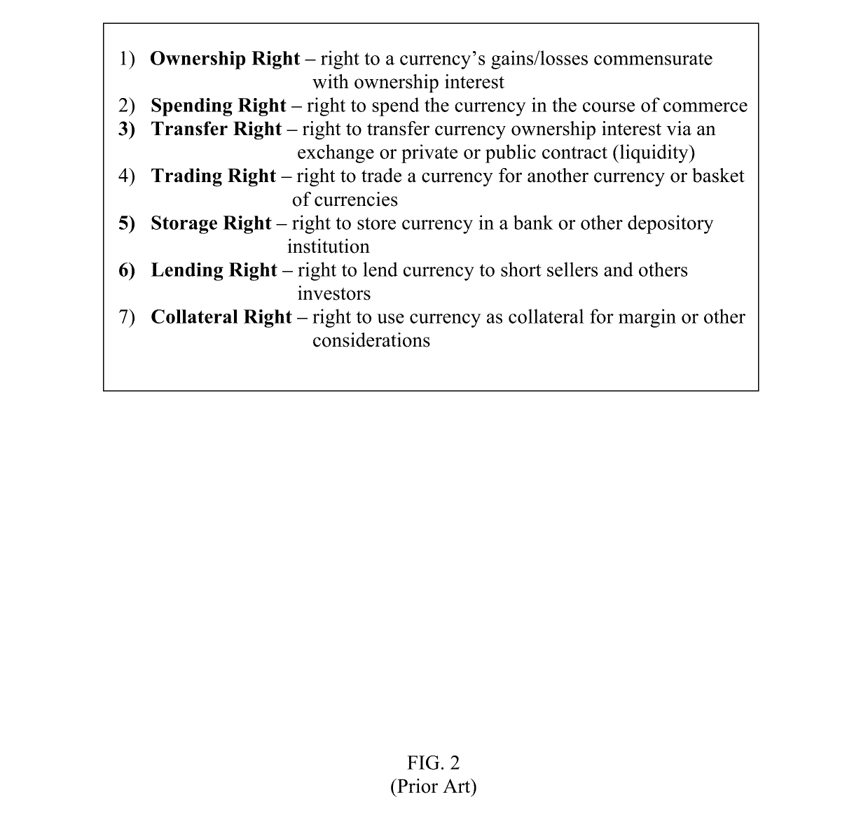

FIG. 3 sets forth a set of equations that formally recognize and describe a broad set of currency trading rights (FXR (α . . . η, $)) possessed, and grantable, by a central bank prior to introduction of a currency into the global financial marketplace, which can be separated and structured into a package of currency trading rights to be issued as a currency trading rights package to suit perfectly a central bank's needs, and illustrating that, in accordance with the principles of the present invention, this set of currency trading individual rights is divisible and combinable, and each individual currency trading right is separately able to be withheld, prior to introduction of a currency, or transferred, in a non-mutually exclusive manner, so as to maximize the utility of a currency to a central bank in the global marketplace, in a manner akin to the bundle of rights possessed through ownership of land, including rights pertaining to minerals, timber, agriculture, surface usage, water usage, air usage, and riparian and development rights, to name the most common individual rights associated with owning and/or holding real property;

FIG. 4 is a high-level systems block diagram representation of the Internet-based Foreign Exchange Rights Management Process (FXRMP) Network of the Present Invention, realized as a carrier-class, globally-extensive packet-switched financial information management and communications network, designed and implemented on a Java-based, object-oriented integrated development environment (IDE) such as, for example, WebObjects 5.2 IDE by Apple Computer Inc, Websphere IDE by IBM, or Weblogic IDE by BEA, or Microsoft® Visual Studio 2005.NET IDE;

FIG. 4A is a schematic representation of a first enterprise-level implementation of the FXRMP Network of the present invention;

FIG. 4B is a schematic representation of a second enterprise-level implementation of the FXRMP Network of the present invention;

FIG. 5 is a schematic representation of the currency trading rights withholding process of the FXRMP Network of the present invention carried out on the FXRMP Network shown in FIG. 4, wherein only the currency trading right to lend a currency (FXR (ζ, $) is withheld and retained by a central bank prior to introduction (or is reclaimed post-introduction) into the global financial marketplace, while the remaining subset of currency trading rights (FXR (α . . . η, $))-(FXR (ζ, $)) is introduced to the global financial marketplace by a central bank. By withholding the currency trading right to lend (FXR (ζ, $)) from the newly-formed currency package of trading rights, the central bank has effectively precluded anyone holding or storing the currency from lending it to short-sellers, thereby allowing both the central bank and currency holders to maximize the utility of the currency in the global marketplace in accordance with principles of the present invention;

FIG. 5A is a schematic representation of the currency trading rights withholding process of the FXRMP Network of the present invention carried out on the FXRMP Network shown in FIG. 4, wherein only the currency trading right to own a currency (FXR (α, $) is withheld and retained by a central bank prior to introduction (or is reclaimed post-introduction) into the global financial marketplace, while the remaining subset of currency trading rights (FXR (α . . . η, $))-(FXR (α, $)) is introduced to the global financial marketplace by a central bank. By withholding the currency trading ownership right (FXR (α, $)) from the newly-formed currency package of trading rights, the central bank has effectively precluded any market participant from excessively buying its currency, thereby allowing the central bank to maximize the utility of the currency with regard to its country's economy in accordance with principles of the present invention;

FIG. 6A is a schematic representation of the Foreign Exchange Rights Management Process (FXRMP) of the Present Invention carried out on the FXRMP Network shown in FIG. 6A, wherein only the currency trading right to lend a currency (FXR (ζ, $)) is withheld and retained by a central bank prior to sale or lease into the global financial marketplace, while the remaining subset of currency trading rights (FXR (α . . . η, $))-(FXR (ζ, $)) is introduced into the global financial marketplace, thereby effectively precluding anyone holding the currency from lending it to short-sellers for short-selling purposes, and allowing both the central bank and a currency holder to maximize the utility of the currency in the global marketplace in accordance with principles of the present invention;

FIG. 6B is a schematic representation of the FXRMP of the present invention carried out on the FXRMP Network shown in FIG. 4, wherein its various components interact so as to enable a central bank to withhold, retain, and transfer the currency trading right to lend a currency (FXR (ζ, $)), while retaining the right to withhold one or more currency trading rights associated with a currency, in order to help a central bank to achieve its goals with respect to currency management, and with respect to its ability to control and profit from the retention, and transference of, the withheld currency trading right to lend (FXR (ζ, $));

FIG. 6C is a flow chart depicting the various steps carried out during the Implementation of the Foreign Exchange Rights Management Process (FXRMP) of the present invention depicted in FIG. 6B illustrating the withholding and retention by a central bank, of the currency trading right to lend (FXR (ζ, $));

FIG. 6D is a schematic representation of the Foreign Exchange Rights Management Process (FXRMP) of the Present Invention carried out on the FXRMP Network shown in FIG. 6A, wherein only the currency trading ownership right (FXR (α, $)) is withheld and retained by a central bank prior to sale or lease into the global financial marketplace, while the remaining subset of currency trading rights (FXR (α . . . η, $))-(FXR (α, $)) is introduced into the global financial marketplace, thereby effectively precluding anyone from buying the currency excessively to drive it higher, and allowing the central bank to maximize the utility of the currency, with respect to its country's economy, in the global marketplace in accordance with principles of the present invention;

FIG. 6E is a schematic representation of the FXRMP of the present invention carried out on the FXRMP Network shown in FIG. 4, wherein its various components interact so as to enable a central bank to withhold, retain, lease or transfer the currency trading ownership right (FXR (α, $)), while retaining the right to withhold one or more currency trading rights associated with a currency, in order to help a central bank to achieve its goals with respect to currency management, and with respect to its ability to control and profit from the retention, lease, or transference of, the withheld currency trading ownership right (FXR (α, $));

FIG. 6F is a flow chart depicting the various steps carried out during the Implementation of the Foreign Exchange Rights Management Process (FXRMP) of the present invention depicted in FIG. 6B illustrating the withholding and retention by a central bank, of the currency trading ownership right (FXR (α, $));

FIG. 7 is a schematic representation of a FXRMP Network of the present invention employing a Non-Borrowable (Non-Shortable) Currency Exchange and Network of the present invention illustrating a process whereby central banks that have withheld the currency trading right to lend (FXR (ζ, $)) from their currency trading right(s) package (denoted by an “L” after the currency name), render those currencies non-borrowable and, thus, impossible to short-sell by speculators, hedgers and/or investors—the “L” after the currency name signifies a “long-only” currency. The “Long-Only Currency Exchange” functions just like a normal currency exchange, where buyers buy and sell currencies, and all required transactions are reported to the central banks and to international and federal regulators;

FIG. 7A is a schematic representation of a FXRMP Network of the present invention employing a Non-Purchasable (Non-Owned) Currency Exchange and Network of the present invention illustrating a process whereby central banks that have withheld the currency trading ownership right to lend (FXR (α, $)) from their currency trading right(s) package (denoted by an “NP” after the currency name), render those currencies non-purchasable and, thus, impossible to buy excessively by speculators, hedgers and/or investors—the “NP” after the currency name signifies a “non-purchasable” currency. The “Non-Purchasable Currency Exchange” functions just like a normal currency exchange, where buyers buy and sell currencies, and all required transactions are reported to the central banks and to international and federal regulators;

FIG. 7B is a schematic representation of a first enterprise-level implementation of the FXRMP Network of FIG. 7;

FIG. 7C is a schematic representation of second enterprise-level implementation of the FXRMP Network of the present invention;

FIG. 7D is a flow chart depicting the various steps carried out on the Non-Borrowable (Non-Shortable) Currency Exchange and Network of the Present Invention, shown in FIG. 7;

FIG. 7E is a flow chart depicting the various steps carried out on the Non-Purchasable (Non-Owned) Currency Exchange and Network of the Present Invention, shown in FIG. 7A;

FIG. 8 is a schematic representation of the FXRMP Network of FIG. 4, supporting the FXRMP Network Currency Conversion Process for converting to a Non-Borrowable (Non-Shortable) Currency of the present invention, which allows central banks to convert their currencies (owned or produced) into “long-only” currencies by way of separating and withholding the currency trading right to lend (FXR (ζ, $)), wherein a participating central bank utilizes the FXRMP system to restructure its currency by withholding the currency trading right to lend that currency, and then introduces the new currency trading package of rights into the global financial marketplace, with the central bank retaining the withheld currency trading right to lend its currency to preclude short-selling;

FIG. 8A is a schematic representation of the FXRMP Network of FIG. 4, supporting the FXRMP Network Currency Conversion Process for Converting to a Non-Purchasable (Non-Owned) Currency of the present invention, which allows central banks to convert their currencies (owned or produced) into “non-purchasable” currencies by way of separating and withholding the currency trading ownership right (FXR (α, $)), wherein a participating central bank utilizes the FXRMP system to restructure its currency by withholding the currency trading ownership right to that currency, and then introduces the new currency trading package of rights into the global financial marketplace, with the central bank retaining the withheld currency trading ownership right to its currency to preclude excessive buying of its currency;

FIG. 8B is a schematic representation of a first enterprise-level Implementation of the FXRMP Network of FIG. 8;

FIG. 8C is a schematic representation of a second enterprise-level implementation of the FXRMP Network of FIG. 8;

FIG. 8D is a flow chart depicting the various steps carried out during the FXRMP Network Currency Conversion Process for Converting to a Non-Borrowable (Non-Shortable) Currency of the present invention carried out on the FXRMP Network of FIG. 8;

FIG. 8E is a flow chart depicting the various steps carried out during the FXRMP Network Currency Conversion Process for Converting to a Non-Purchasable (Non-Owned) Currency of the present invention carried out on the FXRMP Network of FIG. 8A;

FIG. 9 is a schematic representation of the FXRMP Network of the Present Invention employing a Central Bank-Controlled Currency Trading Rights Management Exchange (Non-Borrowable Currency) according to the present invention, which allows central banks to control the selling short or excessive purchasing of their currency by determining lease rates, time periods and the amount of total currency right(s) available with the associated leasing of the withheld currency trading right to lend (FXR (ζ, $)), needed by short-sellers or to short the currency;

FIG. 9A is a schematic representation of the FXRMP Network of the Present Invention employing a Central Bank-Controlled Currency Trading Rights Management Exchange (Non-Purchasable Currency) according to the present invention, which allows central banks to control excessive purchasing of their currency by determining lease rates, time periods and the amount of total currency right(s) available with the associated leasing of the withheld currency trading ownership right (FXR (α, $)), needed by purchasers to purchase the currency;

FIG. 9B is a schematic representation of a first enterprise-level implementation of the FXRMP Network of FIGS. 9 & 9A;

FIG. 9C is a schematic representation of a second enterprise-level implementation of the FXRMP Network of FIGS. 9 & 9A; and

FIG. 9D is a flow chart depicting the various steps carried out during the Central Bank-Controlled Currency Trading Rights Management Exchange (Non-Borrowable Currency) of the present invention supported on the FXRMP Network of FIG. 9.

FIG. 9E is a flow chart depicting the various steps carried out during the Central Bank-Controlled Currency Trading Rights Management Exchange (Non-Purchasable Currency) of the present invention supported on the FXRMP Network of FIG. 9A.

FIG. 10 is a FXRM Network Central Bank-Controlled Currency Trading Rights Management Exchange Process for Establishing Currency Trading Rights Borrowing Rates graphical user interface (GUI) screen that allows a central bank to set the borrowing terms for its currency trading right to lend its currency and through which, a currency borrower selects various accounts and terms from both from drop-down menus and by typing in pertinent information related to the borrowing of the currency trading right to lend from the central bank.

FIG. 10A is a flow chart depicting the various steps carried out during the FXRM Network Central Bank-Controlled Currency Trading Rights Management Exchange Process for Establishing Currency Lending Rights Lease Rates on a graphical user interface (GUI) screen.

FIG. 11 is a FXRM Network Central Bank-Controlled Currency Trading Rights Management Exchange Process for Currency Lending Rights Lessees graphical user interface (GUI) screen.

FIG. 11A is a flow chart depicting the various steps carried out during the FXRM Network Central Bank-Controlled Currency Trading Rights Management Exchange Process for Currency Lending Rights Lessees on a graphical user interface (GUI) screen.

FIG. 12 is a FXRM Network Central Bank-Controlled Currency Trading Rights Management Exchange Process for Setting Currency Trading Rights Lease or Purchase Limits, which allows a central bank, in this example the European Central Bank (ECB) to establish a range within which, it is comfortable with its currency (Euro) trading vs. the U.S. Dollar (USD) (in this example, 1.3000-1.3600); outside of that range, below 1.3000, a prospective short seller would need to contact the ECB, via the process shown in FIG. 11, to lease (or purchase) the currency trading right to lend (FXR (ζ, $)) in order to short the Euro vs. the USD, and above 1.3600, a prospective buyer of the Euro vs. the USD would need to lease (or purchase) the currency trading ownership right (FXR (α, $)) in order to purchase the Euro vs. the USD.

FIG. 12A is a flow chart depicting the various steps carried out during the FXRM Network Central Bank-Controlled Currency Trading Rights Management Exchange Process for Setting Currency Trading Rights Lease or Purchase Limits.

### DETAILED DESCRIPTION OF THE ILLUSTRATIVE EMBODIMENTS OF THE PRESENT INVENTION

Referring to the figures in the accompanying Drawings, the illustrative best mode embodiments of the present invention will now be described in greater technical detail, wherein like parts are indicated by like reference numbers.

### Overview of the Method of Central Bank Currency Rights Withholding and Transfer According to the Principles of the Present Invention

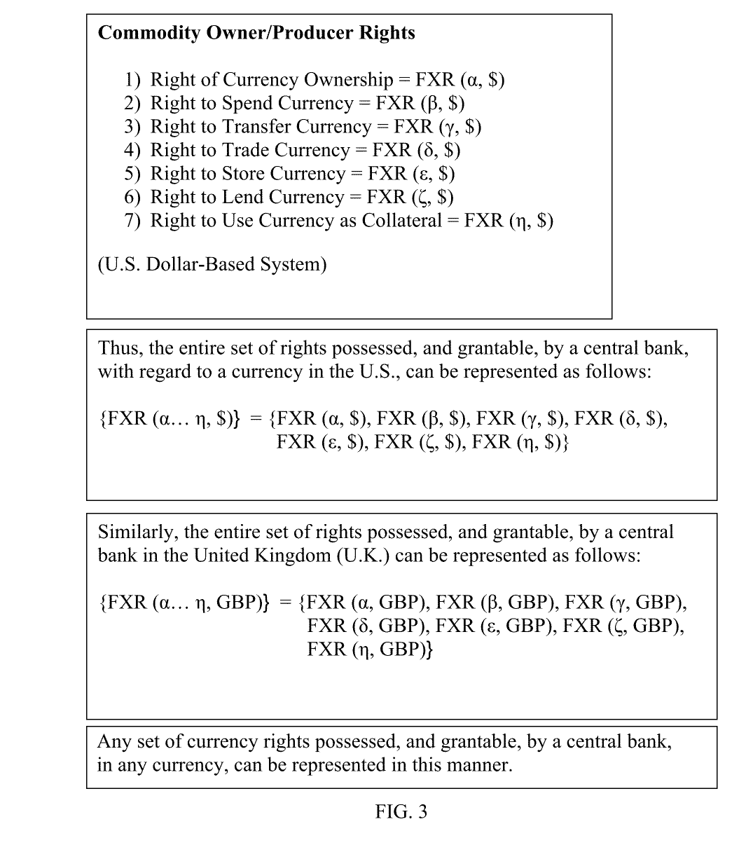

Referring to FIG. 3, there is presented an important set of equations that formally recognizes a broad set of currency trading rights (FXR (α . . . η, $)), possessed and grantable by a central bank, prior to a currency's introduction into the global financial marketplace. In accordance with the principle of the present invention, this set of currency trading rights can be separated and structured into a subset of currency trading rights to be issued as a package of currency trading rights to more perfectly suit a central bank's needs, thereby allowing certain currency trading right(s) to be effectively withheld prior to a currency's introduction by a central bank, which, can be utilized to convert currencies that are already trading in the global financial marketplace into non-borrowable or non-purchasable currencies in accordance with the principles of the present invention. As will be described in greater detail hereinafter, the withholding of such currency trading right(s) prior to a currency's introduction by a central bank, or after a currency's introduction via the conversion process, is carried out using the Foreign Exchange Rights Management Process (FXRMP) of the present invention, which recognizes and ensures that the above-identified set of individual currency trading rights is divisible and combinable prior to a currency's issuance (or post-issuance by the central bank), and that the individual currency trading right to lend currencies (FXR (ζ, $)) and the currency trading ownership right (FXR (α, $)) are separately withholdable prior to a currency's issuance, enabling a central bank to effectively preclude short-selling or excessive buying of its currency—processes central banks have, heretofore, been unable to stop or control to their great detriment.

### Implementation of the Various Embodiments of the FXRMP Information Network of the Present Invention

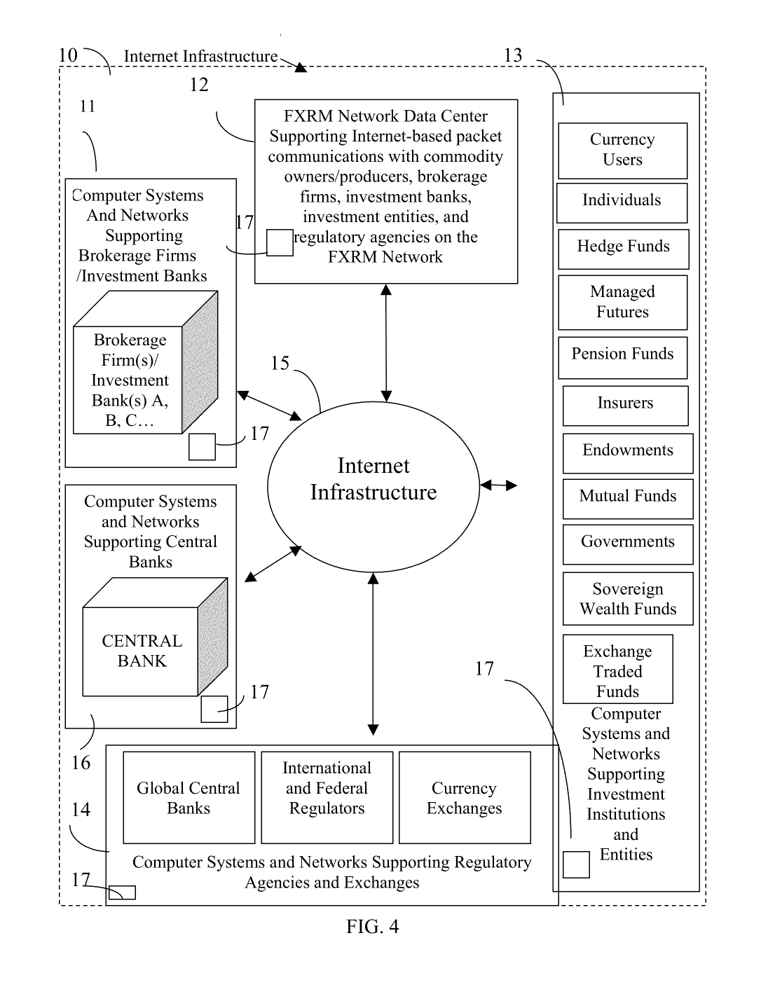

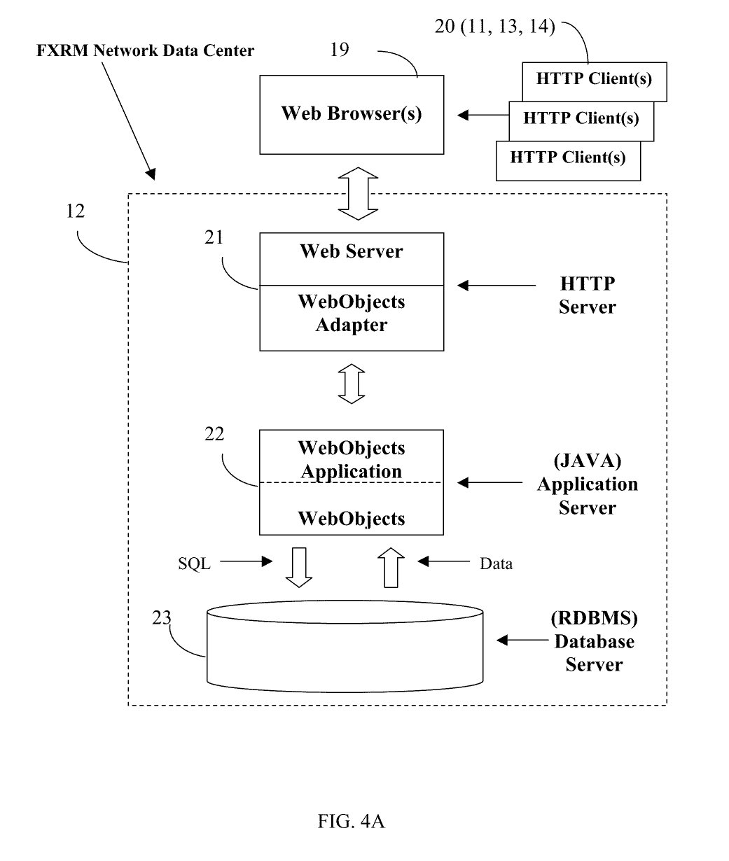

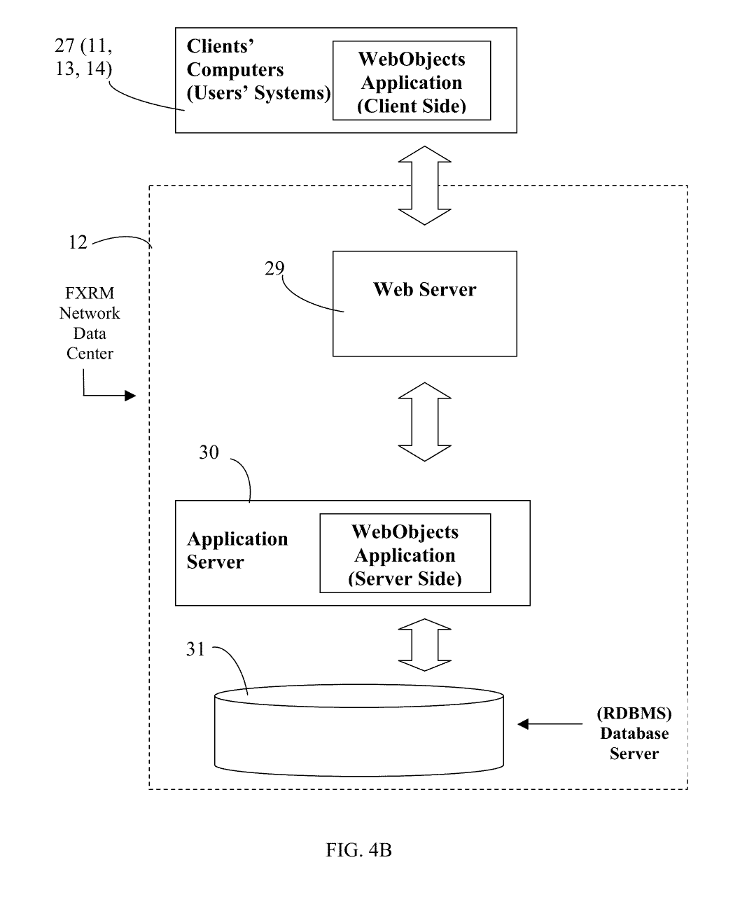

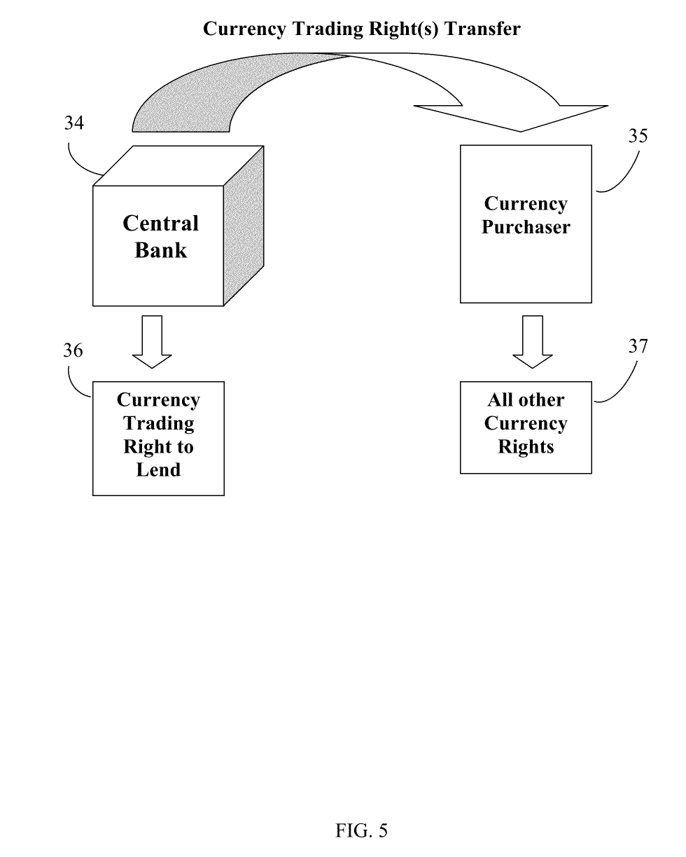

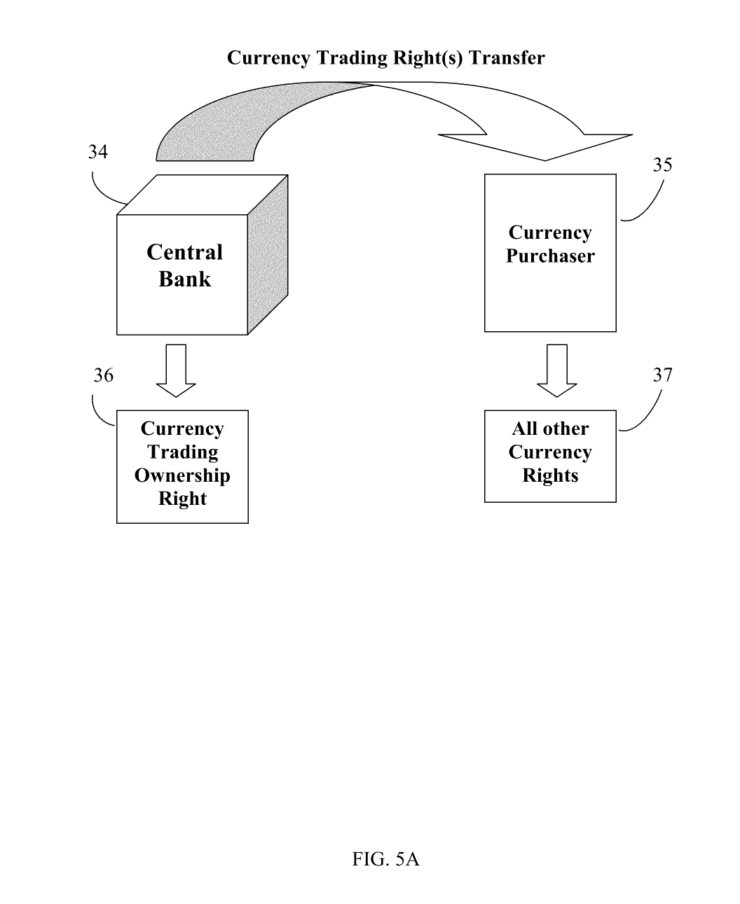

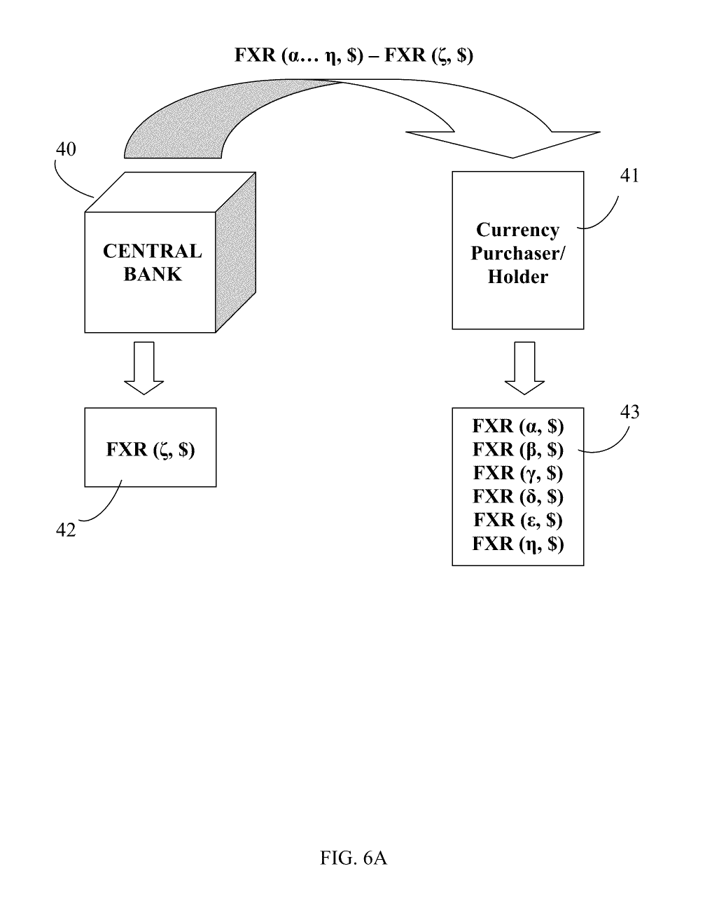

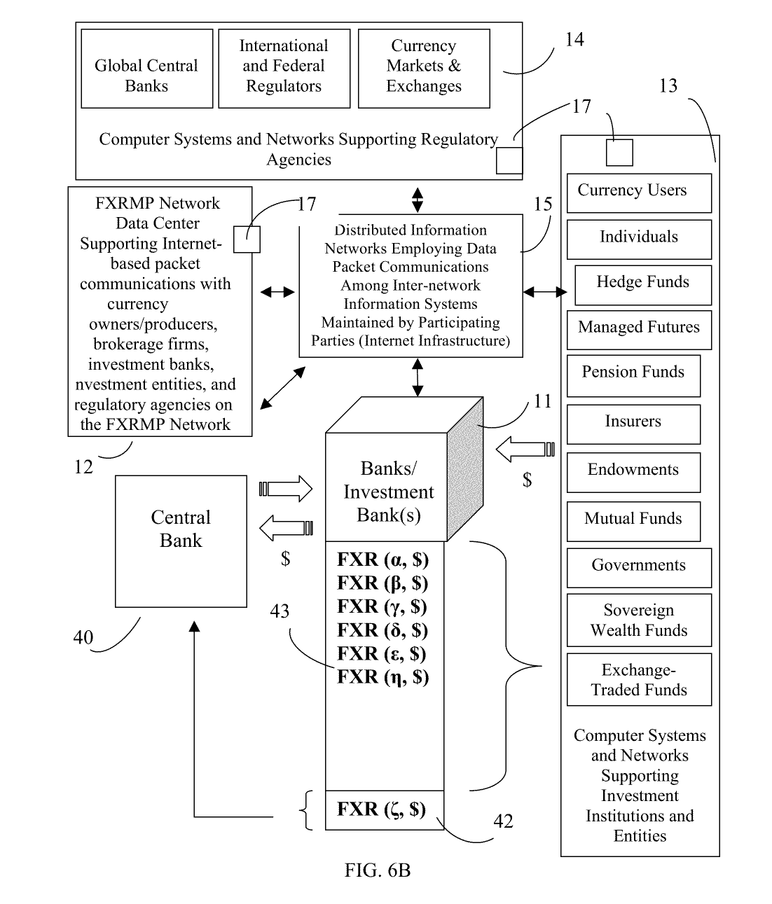

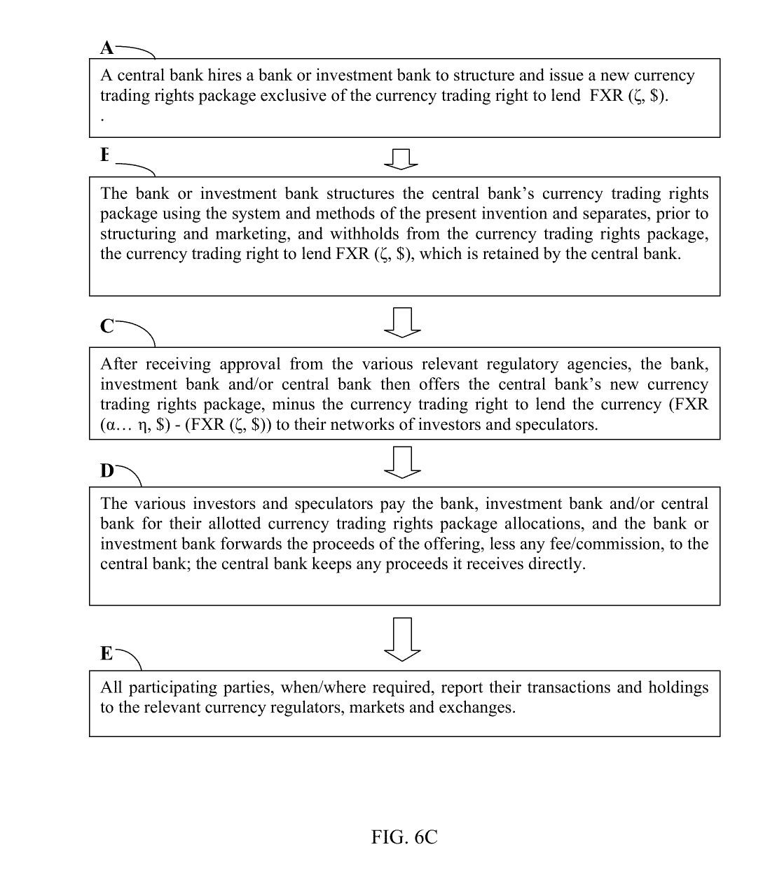

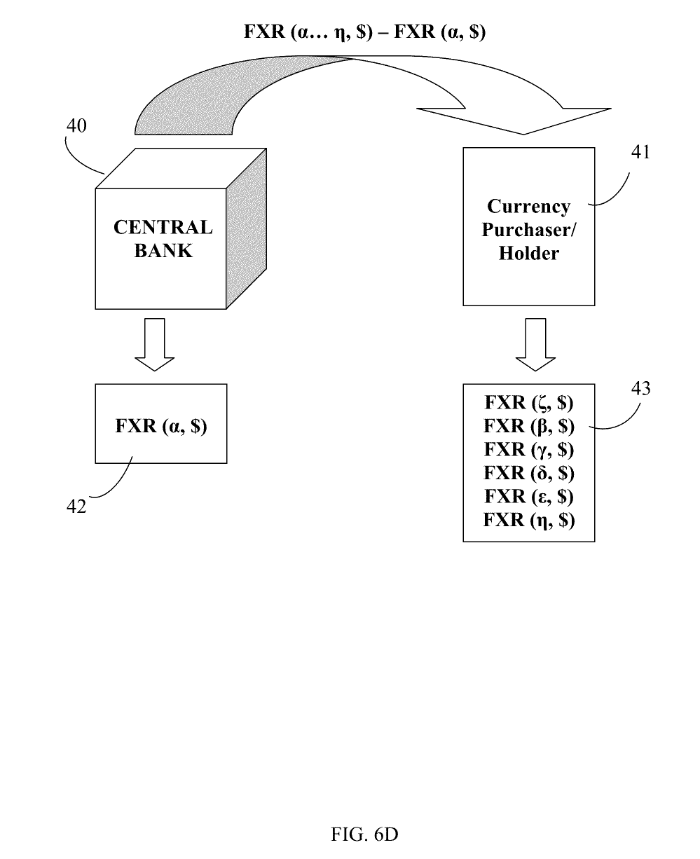

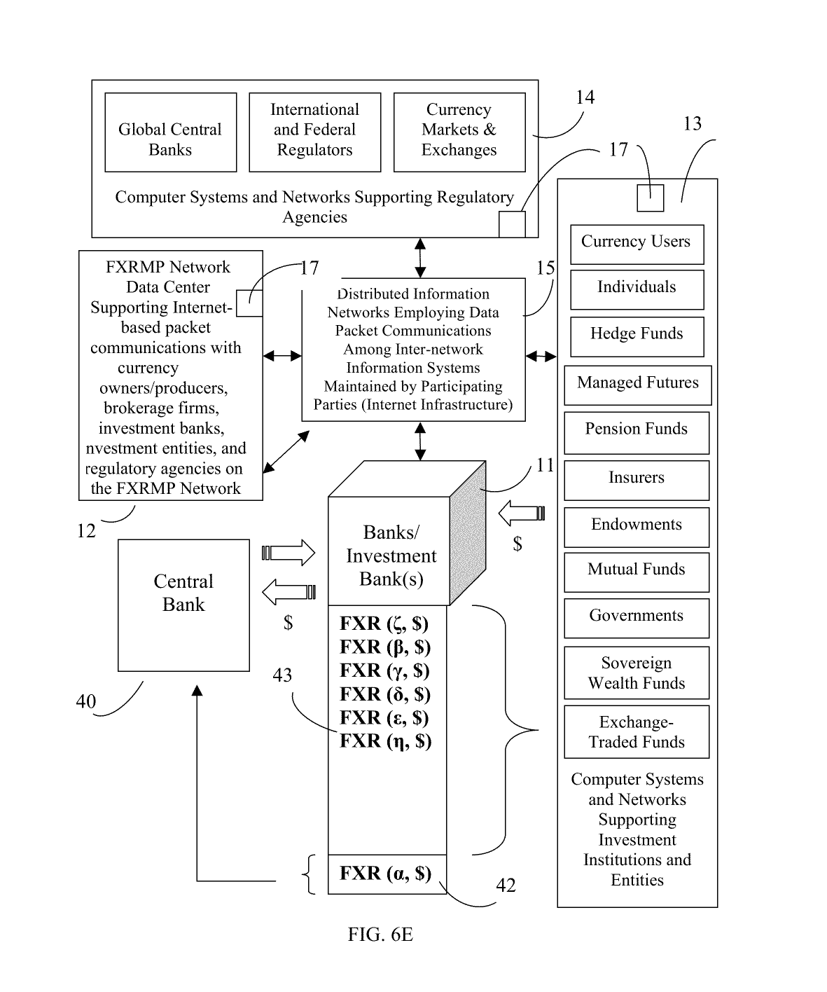

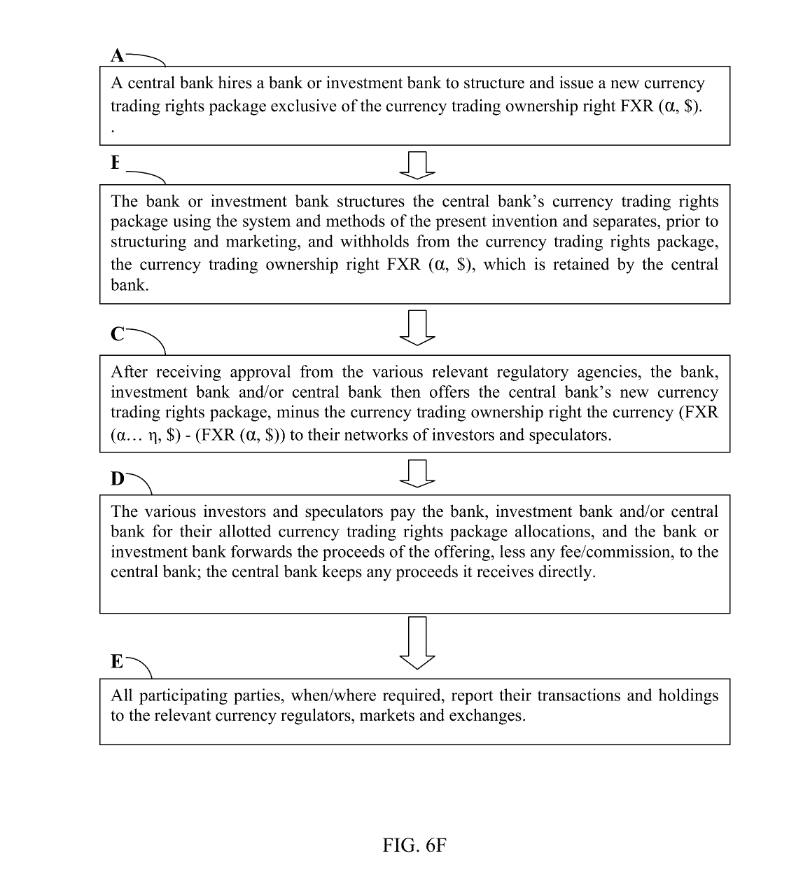

As shown in FIGS. 4 through 7E, the FXRMP Network of the present invention 10 supports services necessary to carry out the FXRMP illustrated in FIGS. 5 and 5A, and the FXRMP illustrated in FIGS. 6A-6E of the present invention. Preferably, the FXRMP Network 10 is designed and implemented as an industrial-strength carrier-class Internet-based financial information communications network of an object-oriented system engineering (OOSE) design, as taught in Applicant's co-pending U.S. application Ser. Nos. 11/328,433 and 11/651,413, each incorporated herein by reference in its entirety.

As shown in FIG. 4, the FXRMP Network 10 comprises a diverse arrangement of computer systems (client and server machines) and networks interfaced with the infrastructure of the Internet, namely: computer systems (client and server machines) and networks supporting brokerage firms and investment banks 11; computer systems (client and server machines) and networks supporting regulatory agencies 14; computer systems (client and server machines) and networks supporting investment institutions and entities 13; computer systems (client and server machines) and networks supporting central banks/governments 16; and the FXRMP Data Center 12 supporting Internet-based packet communications with the brokerage firms, investment banks, investment entities, and regulatory agencies on the FXRMP Network.

As will be described in greater detail hereinafter, the FXRMP Data Center 12 supports various information services between the various computer systems within the network, and among its various users. The FXRMP Data Center 12 will typically include arrays of relational database servers (RDBMS), application servers, and web and other communication servers, arranged in a three-tier structure, and secured by network firewalls, routers, switches and the like, well known in the art.

Each computer system and network within network groups 11, 13, 14 and 16, will typically include arrays of relational database servers (RDBMSs), application servers, and web and other communication servers, arranged in a three-tier structure and secured by network firewalls, routers, switches and the like, in addition to an arrangement of client machines supporting GUI interfaces, with which human users interface in a manner well known in the art.

In practice, the object-oriented FXRMP Network (system) will be developed using available object-oriented technology. Such object-oriented system development can involve any suitable Java-based, object-oriented integrated development environment (IDE) e.g. WebObjects 5.2 by Apple Computer Inc, Websphere IDE by IBM, or Weblogic IDE by BEA; or another object-oriented programming language such as C sharp, supported by the Microsoft® Visual Studio 2005. NET IDE.

FIGS. 4A and 4B show two alternative implementations of the enterprise-level FXRMP network of the present invention 12 shown in FIG. 4 using the WebObjects® IDE and Java Application Server 21, 22, 29, 30. Although it is understood that other IDE' s and server technology platforms can be used to implement and deploy server components of the FXRMP Data Center 12. In FIG. 4A, the FXRMP network implementation involves using Web-based clients that can access services on the FXRMP network using http, well known in the art. In FIG. 4B, the FXRMP network implementation involves using clients programs running on the OS of the client machine, so that the user can access services on the FXRMP network using TCP/IP or other communication protocols known in the art. In other embodiments of the FXRMP network of the present invention, including those shown in FIGS. 4, 7, and 8, combinations of these two approaches can be used in combination, in a manner known in the enterprise level object-oriented system engineering (DOSE) art.

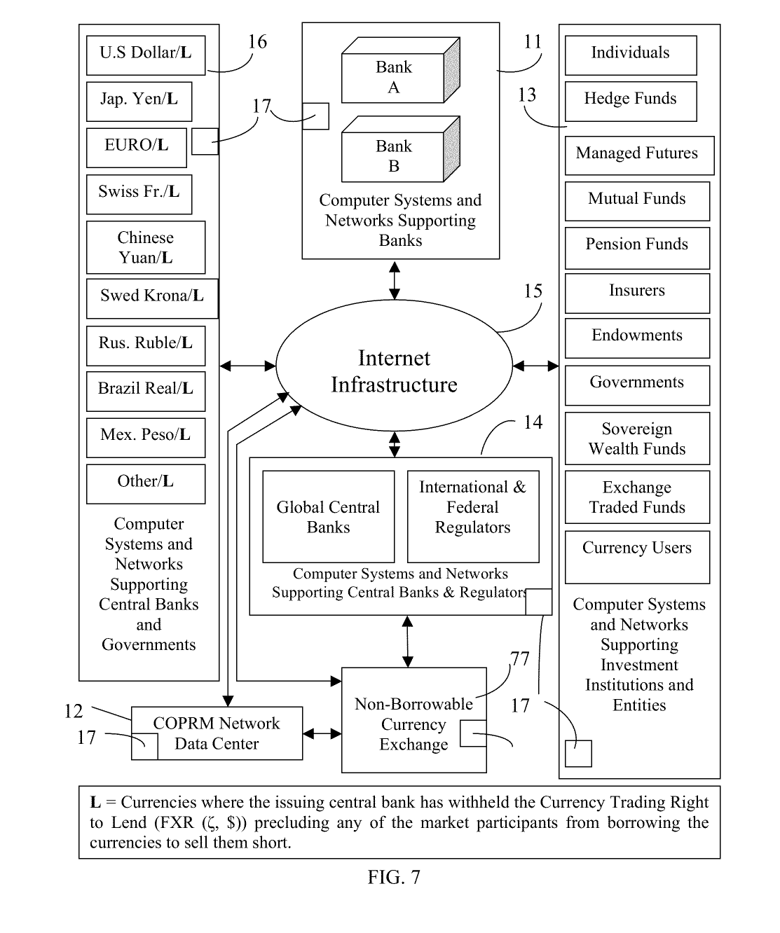

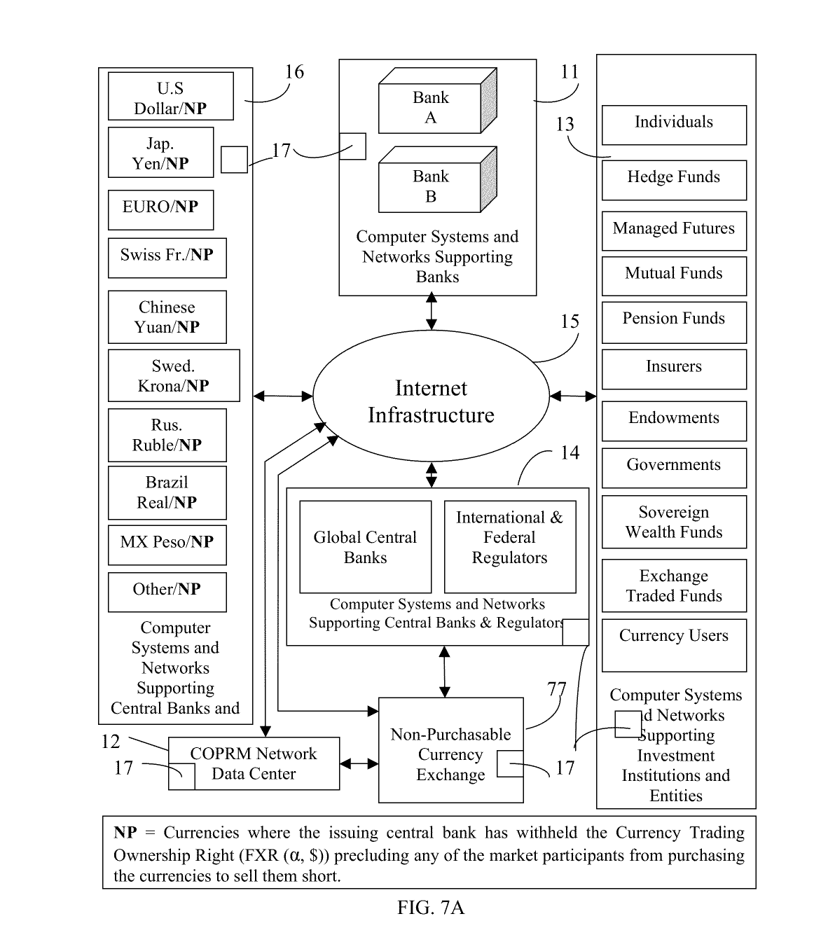

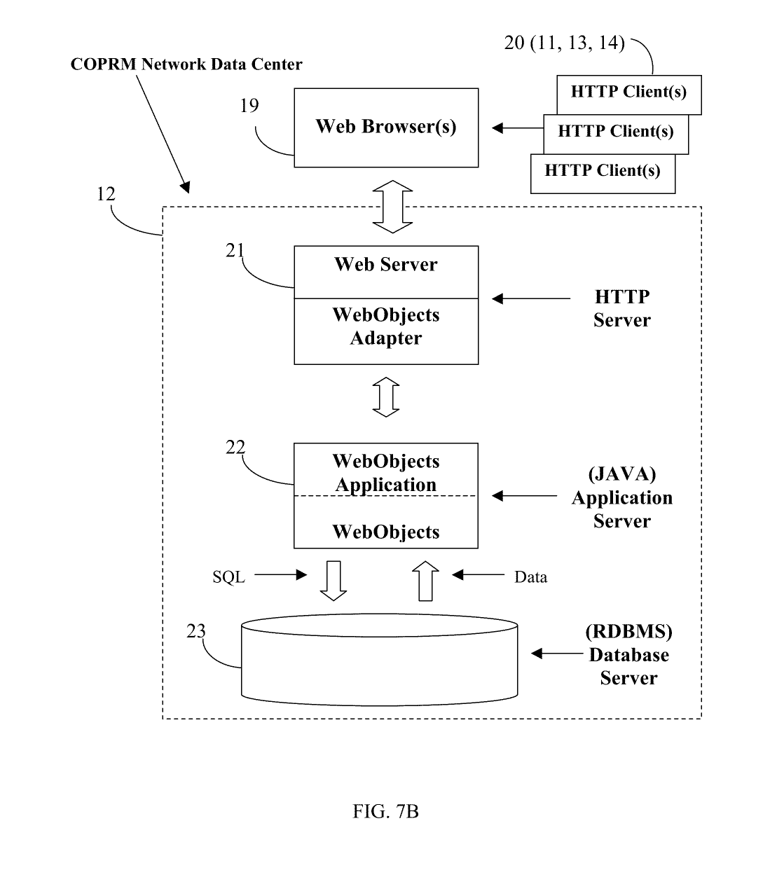

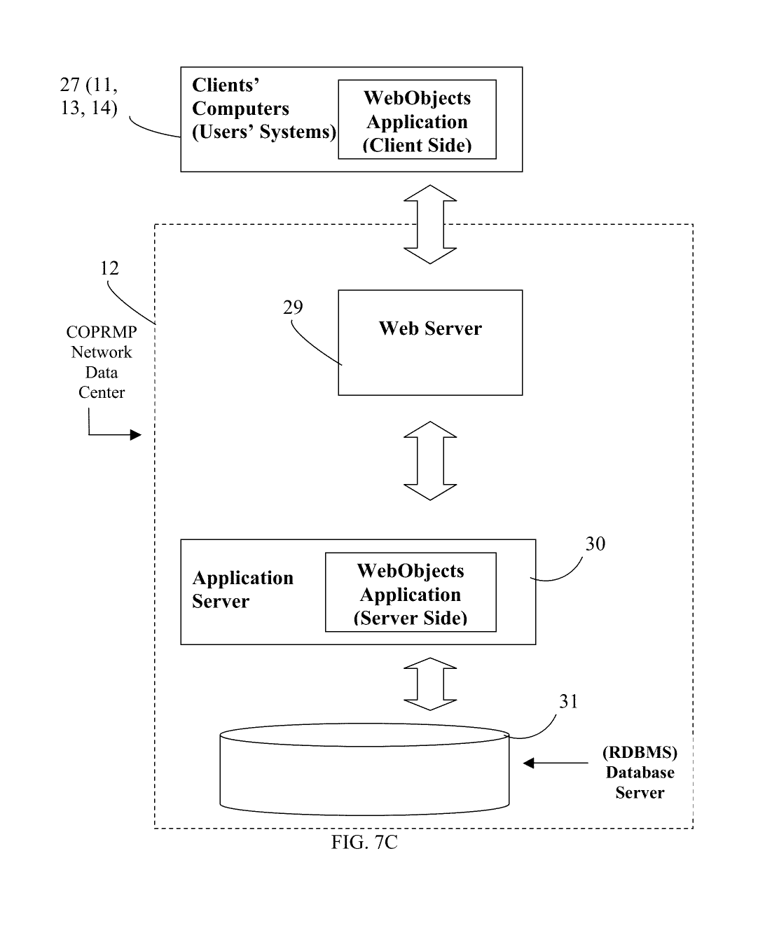

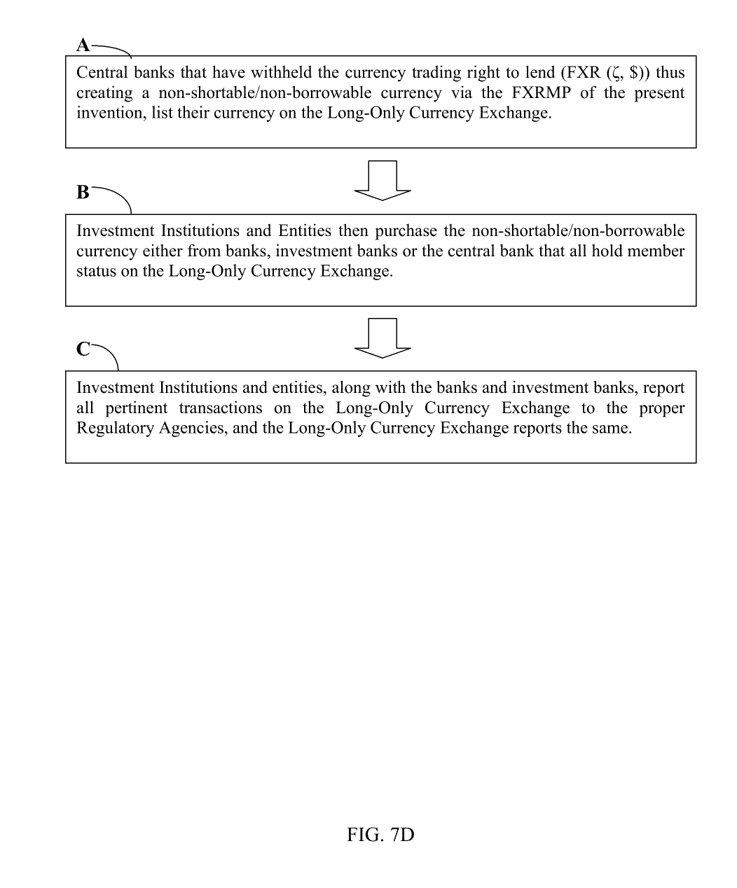

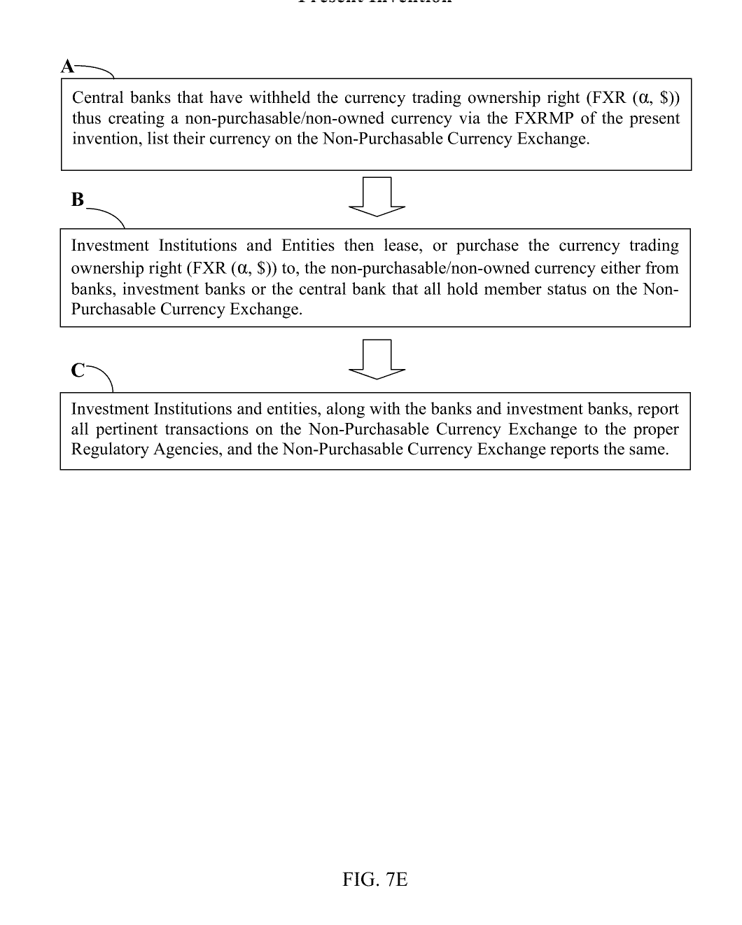

In FIGS. 7 and 7A, additional embodiments of the FXRMP network of the present invention are shown, which are similar to the network in FIG. 4, except that the FXRMP network embodiment shown in FIG. 7 further includes a Long-Only Currency Exchange 77, which supports the non-borrowable (non-shortable) currency exchange process illustrated in the process flow chart of FIG. 7D. The Long-Only Currency Exchange 77 can be realized using the same DOSE technology used to implement the FXRMP Data Center 12 of FIG. 4. And FIG. 7A further includes a Non-Purchasable (Non-Ownable) currency exchange 77 process illustrated in the process flow chart of FIG. 7E. The Non-Purchasable Currency Exchange 77 can be realized using the same DOSE technology used to implement the FXRMP Data Center 12 of FIG. 4.

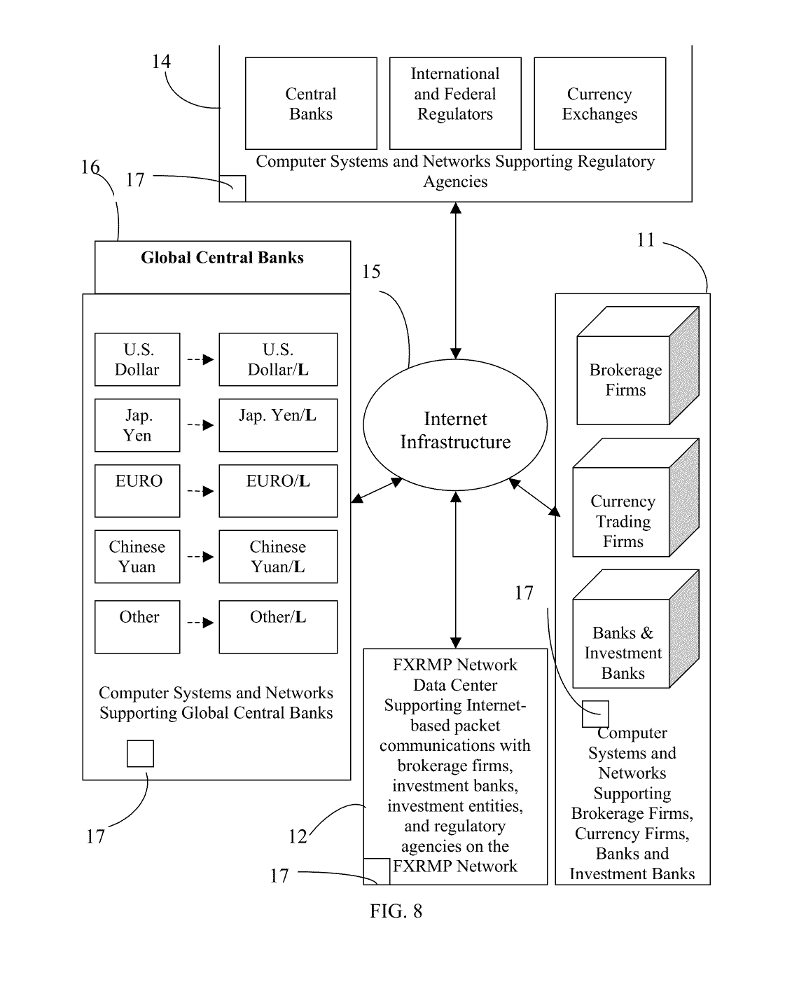

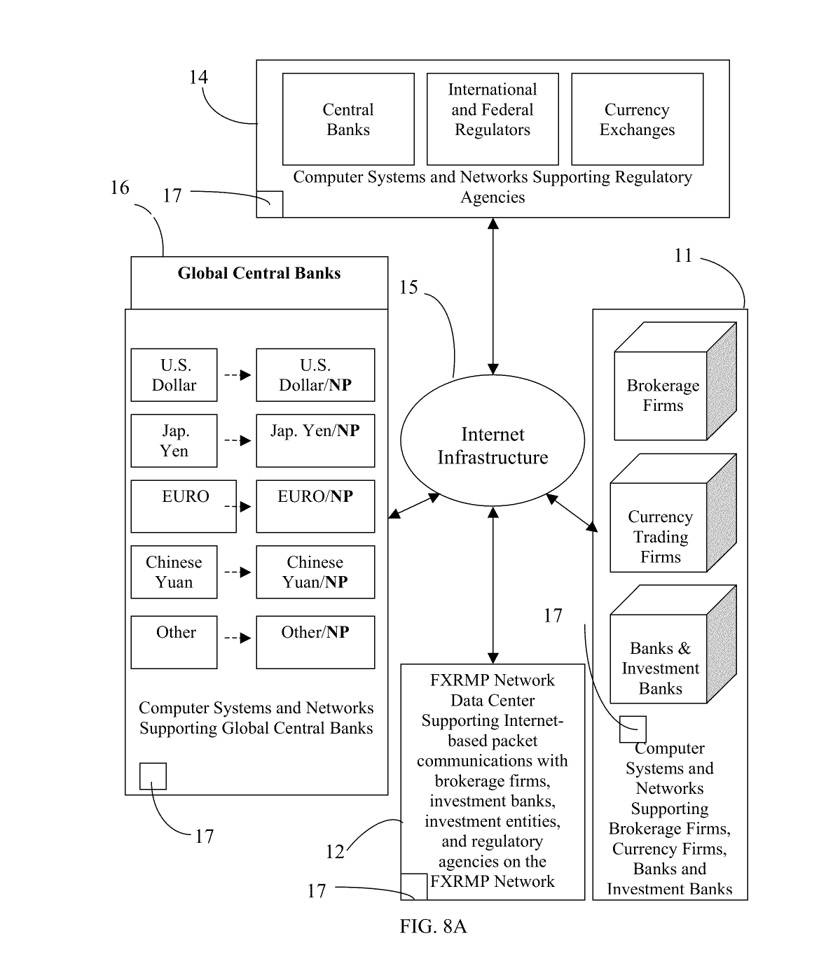

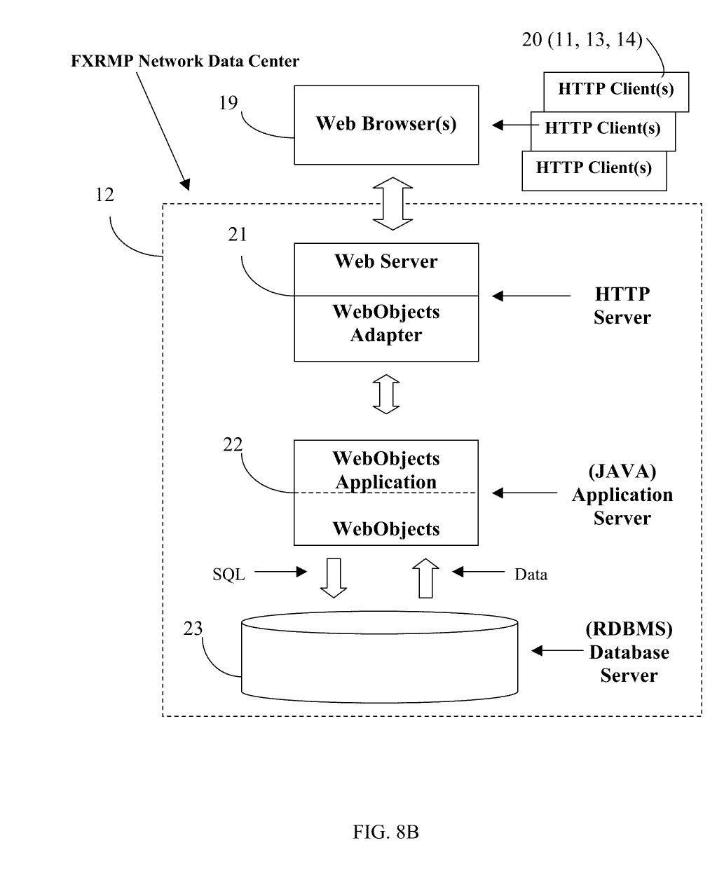

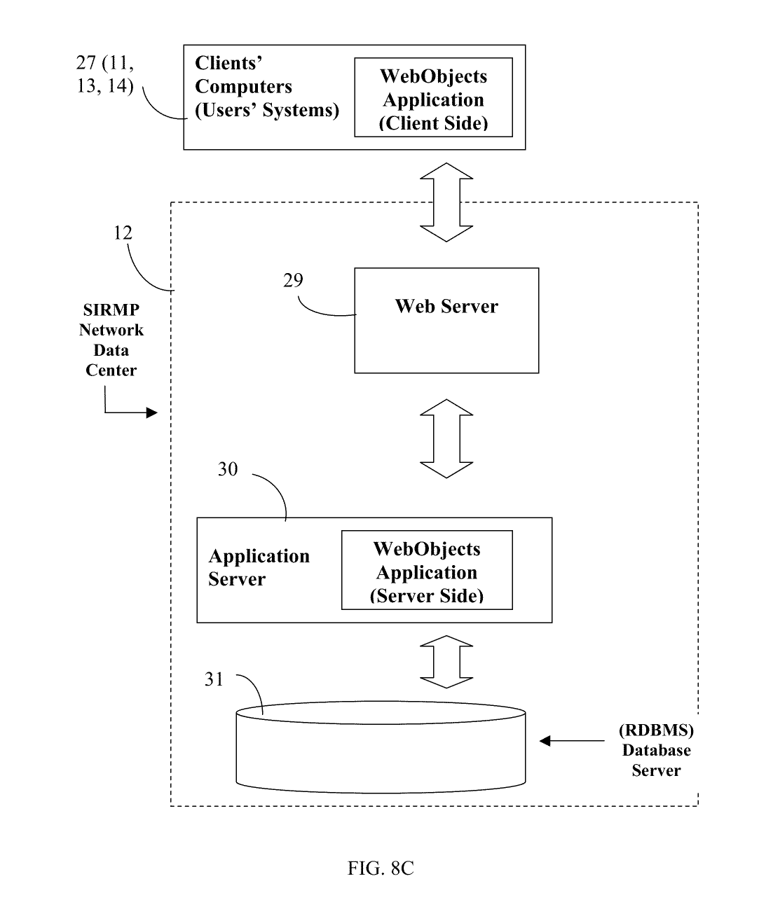

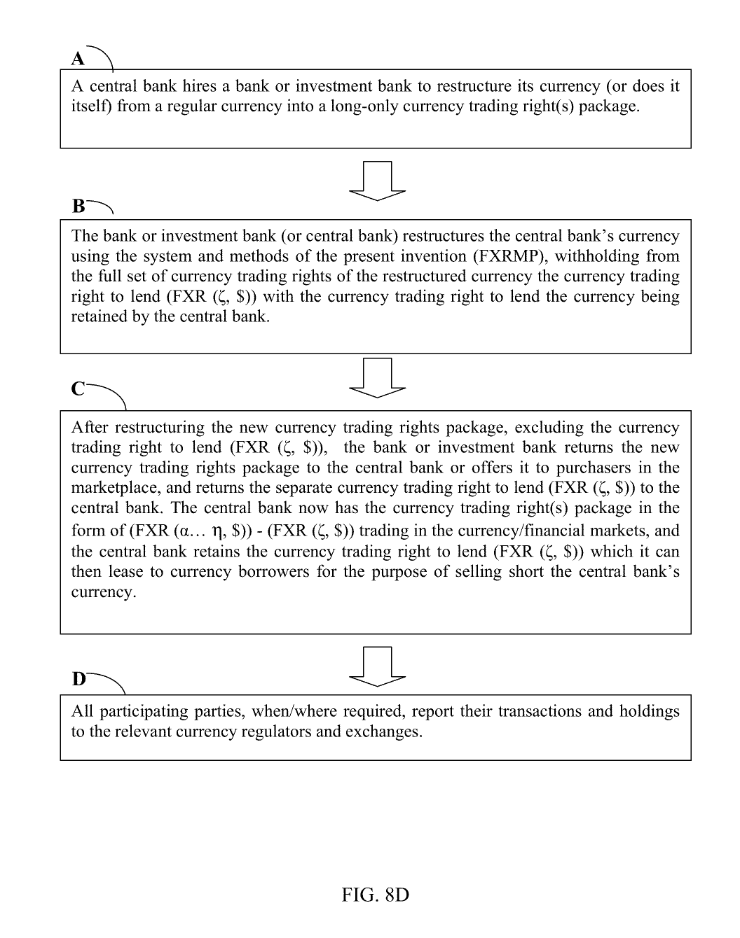

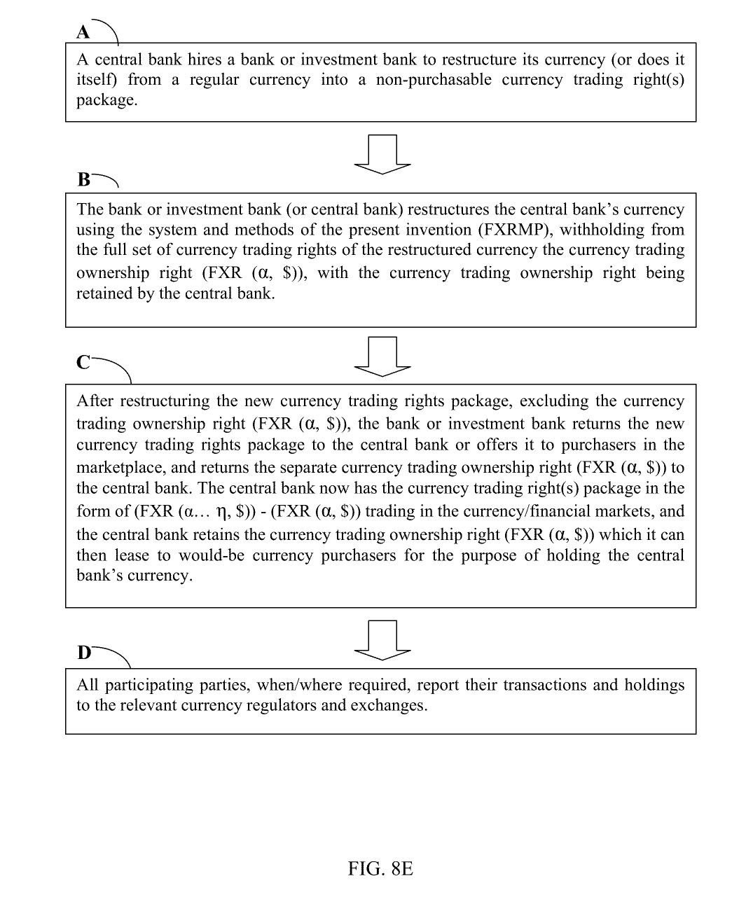

In FIGS. 8 and 8A, additional embodiments of the FXRMP Network of the present invention are shown, which are similar to the network shown in FIG. 4, except that they support the FXRMP Currency Conversion Process of the present invention, illustrated in the block diagrams of FIGS. 8 and 8A, and the process flow charts of FIGS. 8D and 8E respectively.

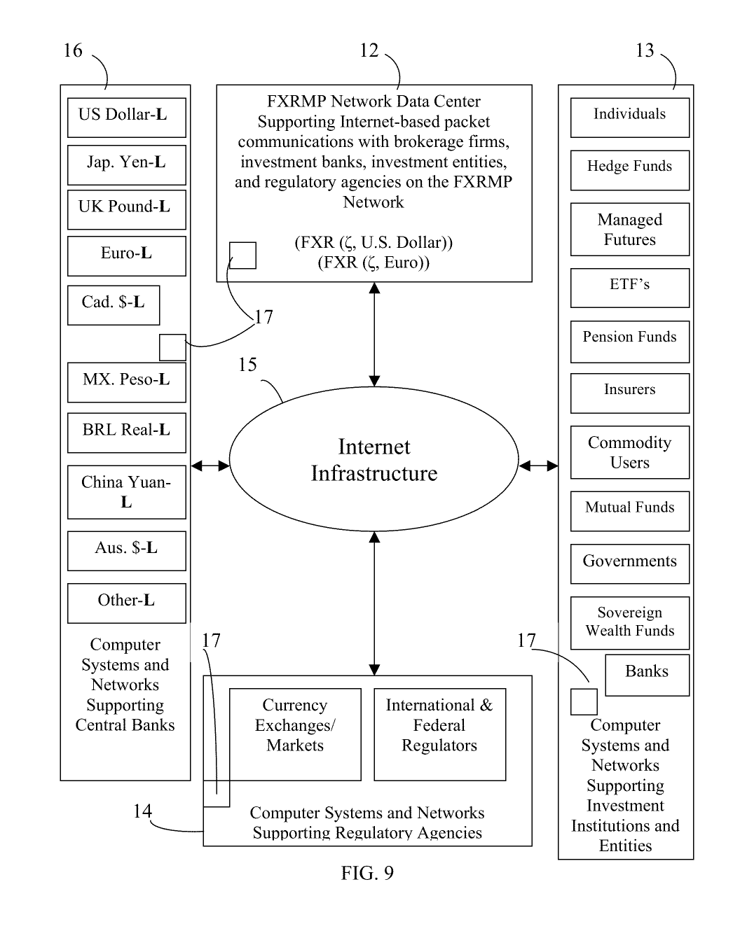

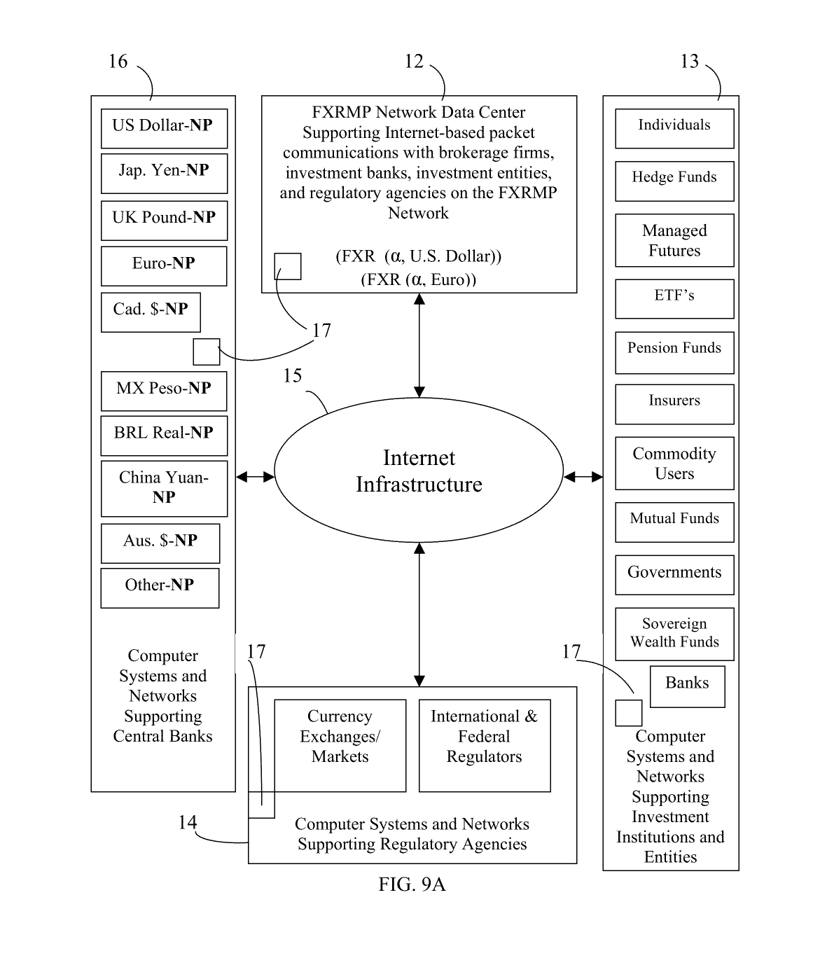

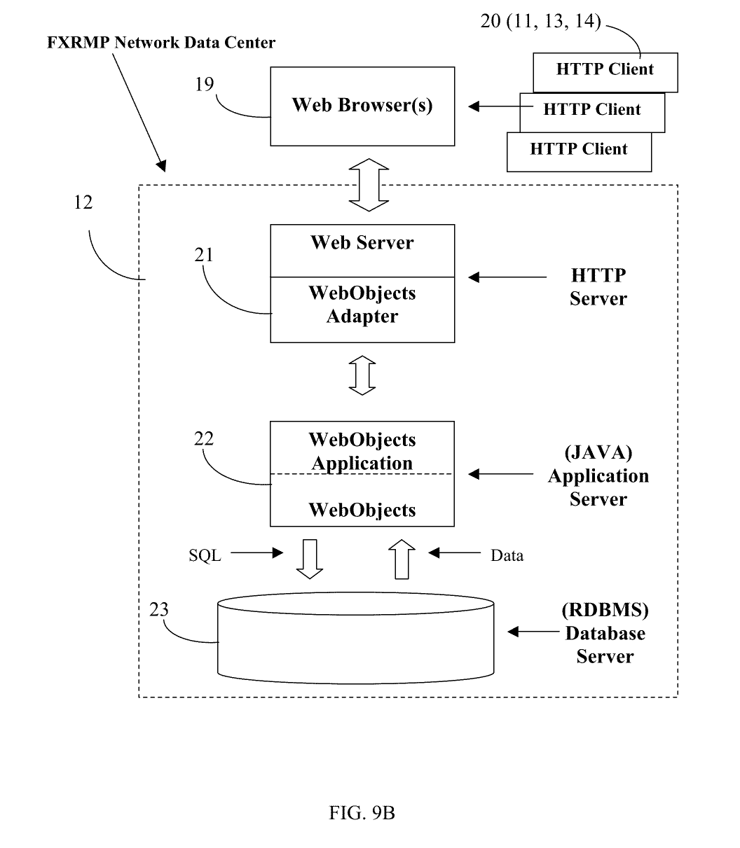

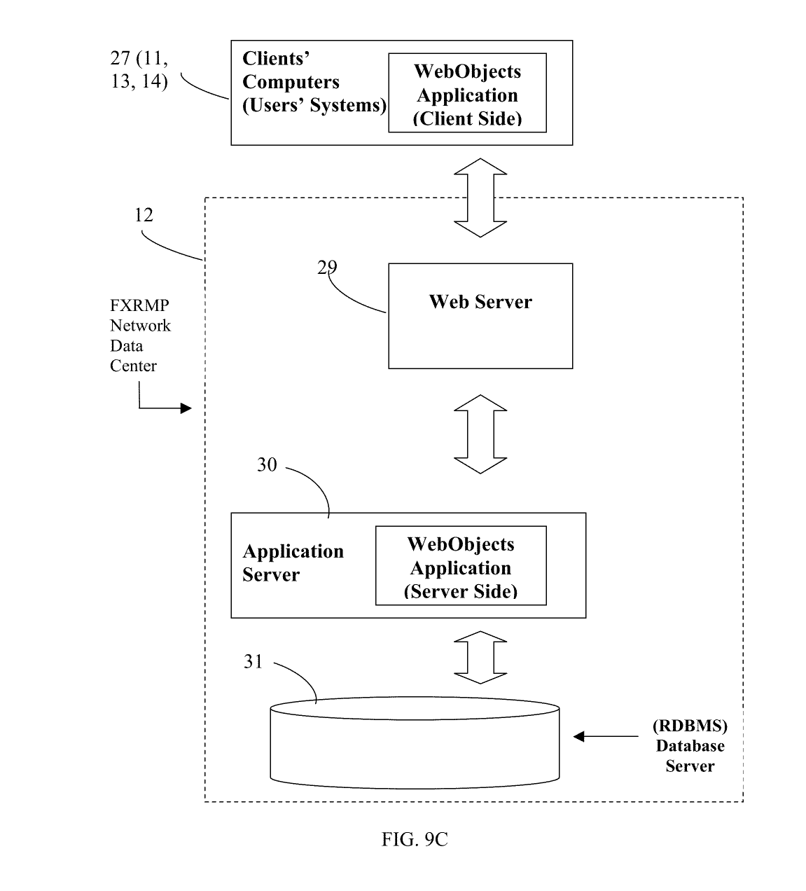

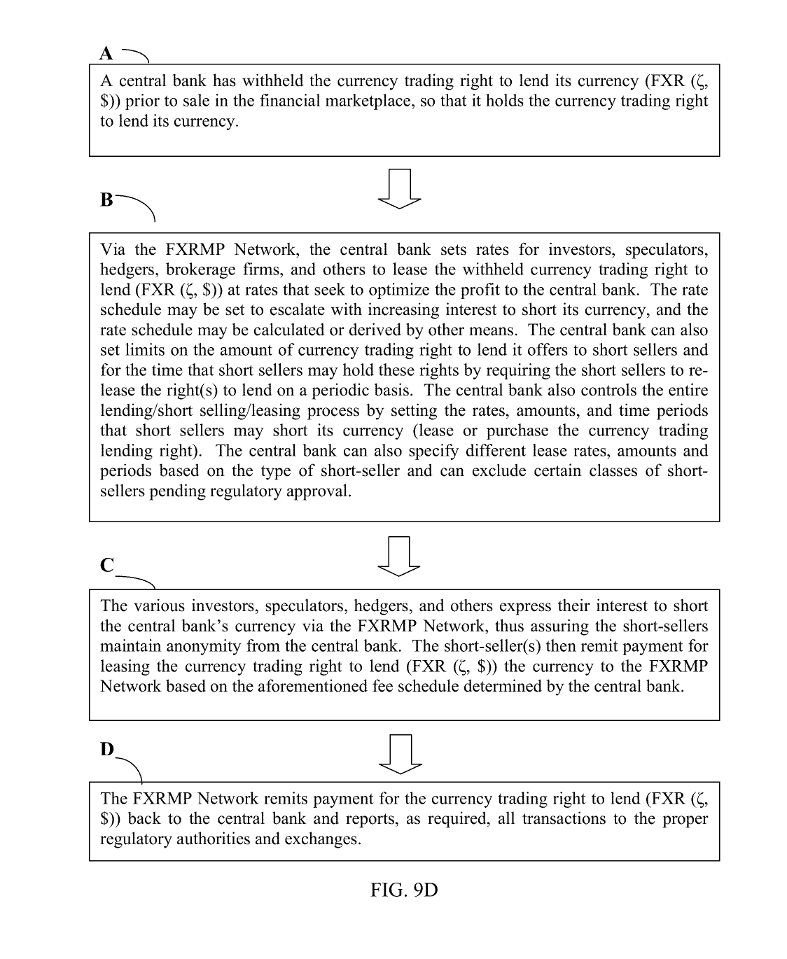

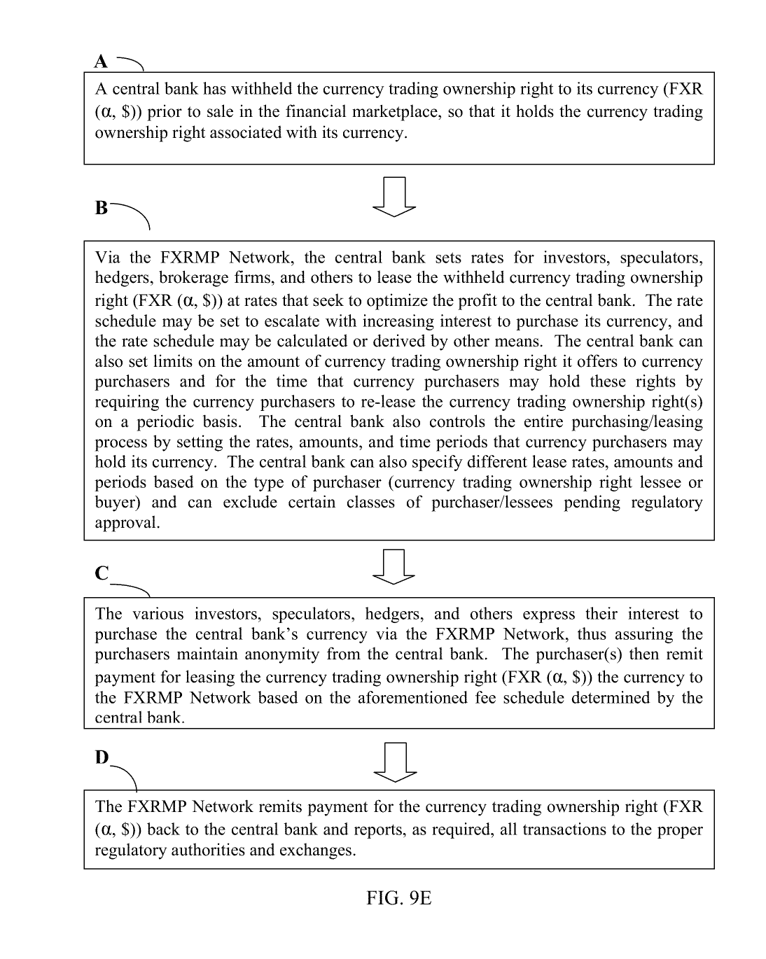

In FIGS. 9 and 9A, two more embodiments of the FXRMP Network of the present invention are shown, which are similar to the network in FIG. 4, except that the FXRMP network embodiment shown in FIGS. 9 and 9A further support the FXRMP Central Bank-Controlled Currency Trading Rights Management Exchanges illustrated in the flow charts of FIGS. 9D and 9E respectively.

It is appropriate at this juncture to provide a brief overview of the Internet-Based FXRMP Network present invention.

### Brief Overview Of The Internet-Based FXRMP Network Of The Present Invention

The Internet-based FXRMP Network of the present invention operates in the global financial marketplace, and comprises an information network infrastructure operably connected to the infrastructure of the Internet, as shown in FIG. 4. The FXRMP Network includes one or more central banks, and a network level financial accounting system 17 that is supported by the web, application and RDBMS servers in the Data Center 12, and various component servers distributed throughout the FXRMP Network of the present invention, over participating central banks, governments, government agencies, financial institutions, and investors. The network level financial accounting system 17 is a component of the object-oriented software-based system that is supported by the web, application and RDBMS servers configured according to a multi-tier network architecture, residing in the FXRMP Data Center 12, and various component servers distributed over the network of participating central banks, government agencies, financial institutions, and investors.

The network-level financial accounting system (i) recognizes and accounts for a set of currency trading rights possessed prior to a currency's introduction into the global financial marketplace by a central bank and (ii) ensures that said set of currency trading rights is unbundled, separated into a plurality of individual currency trading rights (FXR (α . . . η, $)), including the currency trading right to lend (FXR (ζ, $) and the currency trading ownership right (FXR (α, $), and recombined into new, marketable currency rights packages that exclude the currency trading right to lend (FXR (ζ, $) or the currency trading ownership right (FXR (α, $).

In accordance with the principles of the present invention, the central bank (i) withholds from, and prior to, a currency's introduction, the currency trading right to lend (FXR (ζ, $)) the currency, or the currency trading ownership right (FXR (α, $) in order to preclude lending/borrowing of the currency or excessive purchasing of the currency and, thus, to preclude short sales of the currency or excessive buying of the currency, (ii) restructures an already introduced currency to exclude from the new currency trading right(s) package, and to retain, the currency trading right to lend (FXR (ζ, $)) or the currency trading ownership right (FXR (α, $) to the currency in order to preclude lending/borrowing of the currency or excessive buying of the currency and, thus, to preclude short sales of the currency or excessive purchasing of the currency.

When a transfer of the individual currency trading right(s) to lend a currency or the individual currency trading ownership right occurs, the Internet-based FXRMP system/network automatically accounts for the location of that/those rights and collects and remits proper payment to the central bank in exchange for those rights.

### Foreign Exchange Rights Management Process (FXRMP) of the Present Invention

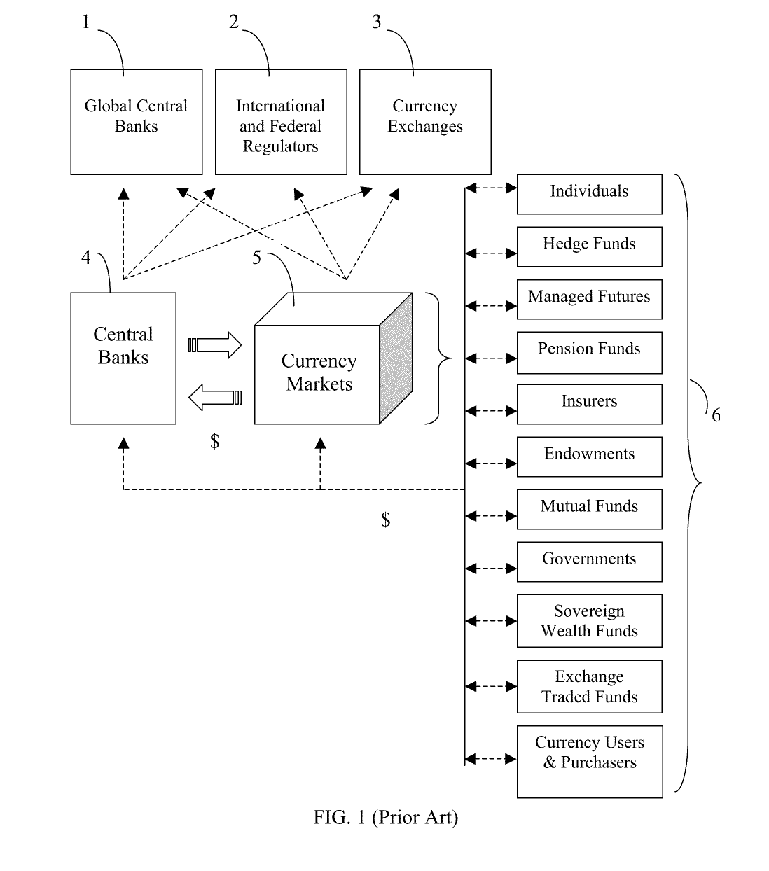

As shown in FIGS. 5 and 5A, the Foreign Exchange Rights Management Process (FXRMP) of the present invention represents a significant improvement over the conventional currency introduction/trading process (Prior Art) as illustrated in FIG. 1. In FIG. 5, the FXRMP is shown with a central bank 34 withholding, prior to introduction, the currency trading right to lend (FXR (ζ, $) 36 its currency in order to allow a central bank 34 to prevent that currency, at introduction (or thereafter), from being lent to speculators and investors for the purpose of borrowing that currency to short-sell it into the market; at the same time, all of the other currency trading rights 37 within the bundle possessed prior to issuance by the central bank 34 are issued to a purchaser 35 of the currency right package for full use by an owner or holder to maximize the utility of the currency held in the global financial marketplace, in accordance with the principles of the present invention.

By withholding the currency trading right to lend the currency (FXR (ζ, $) prior to its introduction, the central bank has effectively precluded a short-sale of the currency, as it cannot be sourced and borrowed by a speculator or investor for the purpose of selling it short. The central bank 34 has effectively prevented short-selling of this currency making it safer for long-term investors to purchase and hold, because only those actually holding the currency will be able to sell it to other interested buyers, and because the currency will not be available for those looking to sell it short as a hedge against derivative instruments bought/sold on the underlying currency. If it is impossible to hedge derivative instruments by shorting a currency, there will be less speculative selling pressure on the currency, which will give central banks greater flexibility in raising capital or borrowing capital to fund future economic growth.

The practice of short-selling is often defended with the argument that it adds liquidity to the market. To combat the potential issue of reduced liquidity, the central bank 34 could simply increase the amount of the currency trading right(s) packages introduced into the market. This increased amount of the currency trading right(s) packages will help provide additional market liquidity.

In FIG. 5A, the FXRMP is shown with a central bank 34 withholding, prior to introduction, the currency trading ownership right (FXR (α, $) 36 to its currency in order to allow a central bank 34 to prevent that currency, at introduction (or thereafter), from being bought excessively by speculators and investors for the purpose of buying that currency to drive it higher; at the same time, all of the other currency trading rights 37 within the bundle possessed prior to issuance by the central bank 34 are issued to a lessee or purchaser 35 of the currency for full use by an owner or holder to maximize the utility of the currency held in the global financial marketplace, in accordance with the principles of the present invention.

By withholding the currency trading ownership right to the currency (FXR (α, $) prior to its introduction, the central bank has effectively precluded excessive buying of the currency, as it cannot be bought outright, without leasing or purchasing the currency trading ownership right (FXR (α, $), by a speculator or investor for the purpose of driving the currency higher. The central bank 34 has effectively prevented excessive buying of its currency making it safer for long-term investors to purchase and hold, because the currency will not be available for those looking to buy it as a hedge against derivative instruments bought/sold on the underlying currency. If it is impossible to hedge derivative instruments by purchasing a currency, there will be less speculative buying pressure on the currency, which will give central banks greater flexibility in managing their currencies for the good of their domestic companies and investors.

To combat the potential issue of reduced liquidity, the central bank 34 could simply increase the amount of the currency trading right(s) packages introduced into the market. This increased amount of the currency trading right(s) packages will help provide additional market liquidity.

### Foreign Exchange Rights Management Process (FXRMP) of the Present Invention

As shown in FIG. 6A, the FXRMP represents a significant improvement over the conventional currency introduction/trading (Prior Art) as illustrated in FIG. 1. In this figure, the FXRMP is shown with a central bank 40 withholding the individual currency trading right to lend a currency (FXR (ζ, $)) 42 possessed by a central bank 40 prior to a currency's introduction, in order to allow a central bank 40 to prevent that currency, at introduction (or thereafter), from being lent to speculators and investors for the purpose of borrowing that currency to short-sell it into the market, while all of the other currency trading rights within the bundle possessed by the central bank 40 prior to introduction (FXR (α . . . η, $))-(FXR (ζ, $)) 43 are leased or sold to purchasers 41 of the currency as currency trading rights packages for full use by a currency purchaser 40 to maximize the utility of the currency held in the global financial marketplace, in accordance with the principles of the present invention.

By withholding the currency trading right to lend (FXR (ζ, $)) 42 prior to currency introduction, the central bank 40 has effectively precluded a short-sale of the currency, either by the initial purchaser 41 or, by subsequent purchasers 41; it cannot be sourced and borrowed by a speculator or investor for the purpose of selling it short. The central bank 40 has effectively prevented short-selling of the currency, making it safer for long-term investors to purchase and hold, because only those actually holding the currency will be able to sell it to other interested buyers, and because the currency will not be available for those looking to sell it short as a hedge against derivative instruments bought/sold on the underlying currency. Furthermore, by precluding speculators and investors from selling short the currency, speculators and investors cannot pressure a central bank's currency in order to make it more expensive for a central bank/government to raise/borrow new capital for economic growth, nor can speculators and/or investors force a central bank to sell its currency at prices that have been depressed by the speculators and/or investors.

As illustrated in FIG. 6B, the implementation of the Foreign Exchange Rights Management Process (FXRMP) of FIG. 5 is shown incorporating the FXRMP Data Center 12, a central bank 40, banks and/or investment 11, various currency-purchasing entities (individuals, hedge funds, mutual funds, pension funds, insurers, endowments, municipalities, governments, sovereign wealth funds and exchange-traded funds) 13, various regulatory agencies, including the central banks and international and federal regulators, and, finally, the various currency markets and exchanges 14. Each of the aforementioned participants is linked to the others via various communications networks and via the Internet 15.

As shown in FIG. 6B, a central bank 40 hires a bank or investment bank firm (investment bank, etc.) 11, utilizing the FXRMP Data Center 12 of FIG. 4, to help structure the central bank's currency trading right(s) package in order to allow the central bank to maintain the currency trading right to lend (FXR (ζ, $)) 42. The bank or investment bank 11 structures the central bank's 40 new currency trading right(s) package 43 and, at the instruction of the central bank 40, incorporates the system and method of the present invention, whereby the bank or investment bank 11 recognizes that a currency consists of a bundle of currency trading rights (FXR (α . . . η, $)) 42 & 43, which can be unbundled, separated, and recombined into an individual, saleable package of currency trading rights. From this bundle of currency trading rights, the currency trading right to lend (FXR (ζ, $)) 42 is withheld prior to structuring and sale of the currency trading right(s) package in order to allow a central bank 40 to either preclude or control short-selling of its currency in the global financial marketplace.

The bank or investment bank 11 structures the central bank's 40 currency trading right(s) package so that the central bank withholds the currency trading right to lend its currency (FXR (ζ, $)) 42 prior to sale of the new currency trading right(s) package 43, which now is represented by the equation (FXR (α . . . η, $))-(FXR (ζ, $)) 43. The bank or investment bank 11 then offers for purchase the central bank's 40 new currency trading right(s) package 43 to a broad array of investors including: individuals, hedge funds, managed futures funds, pension funds, insurers, endowments, mutual funds, governments, sovereign wealth funds and exchange-traded funds 13. These investors pay the bank or investment bank 11 for their currency trading right(s) packages 43, and the bank or investment bank 11 forwards the proceeds of the offering to the central bank 40 less any previously agreed commission for the bank's/investment bank's services. The central bank 40, the bank or investment bank 11 and, in some cases, various of the currency trading right(s) package purchasing entities 13, report all facets of the currency trading right(s) package's structure, offering terms, sale and purchases to the various regulatory agencies 14 as represented in FIG. 6B.

The central bank 40 has now issued a new currency trading right(s) package 43 and raised new capital but has withheld from the purchasers 13 the currency trading right to lend (FXR (ζ, $)) 42 this currency for the purposes of short-selling this currency, as speculators and investors cannot borrow this currency from the purchasers of the newly-structured currency trading right(s) packages 43 for the purpose of selling them short. Furthermore, it will be much harder for speculators and investors to purchase bearish derivative instruments on the central bank's 40 newly-structured currency trading right(s) packages 43, as the potential sellers of those bearish derivative instruments will be unable to borrow the central bank's 40 newly-structured currency trading right(s) packages 43 to sell short in an effort to hedge their sales of the bearish derivative instruments. The central bank 40 has also effectively precluded leveraged, bearish exchange-traded funds (ETF's) from including the new currency trading right(s) package 43 in their funds, as the ETF's are also precluded from borrowing the currency to sell it short. Holders of the central bank's 40 new currency trading right(s) package 43 enjoy all of the benefits (currency trading rights) of normal currency ownership, except that they cannot lend the new currency trading right(s) package 43 to investors and speculators for the purpose of short-selling it.

As indicated at Block A in FIG. 6C, the central bank hires a bank or investment bank, utilizing the FXRMP of FIG. 5, for the purpose of structuring and issuing a new currency trading right(s) package to withhold the currency trading right to lend (FXR (ζ, $)) the currency. At Block B, the bank or investment bank firm structures the central bank's currency trading right(s) package by withholding/excluding from the new currency trading right(s) package the currency trading right to lend (FXR (ζ, $)) from the central bank's new currency trading right(s) package, which is retained by the central bank. At Block C, the bank or investment bank then issues the central bank's new currency trading right(s) package ((FXR (α . . . η, $)-(FXR (ζ, $)), to its network of investors and speculators. At Block D, the investors and speculators pay for the central bank's new currency trading right(s) package, and the bank or investment bank delivers the proceeds from sale of the new currency trading right(s) offering to the central bank, less any fees/commissions; the currency trading right to lend (FXR (ζ, $)) the new currency trading right(s) package has been withheld and retained by the central bank. At Block E, all parties report required transactions to the various currency regulators and currency markets and exchange(s).

As shown in FIG. 6D, the FXRMP represents a significant improvement over the conventional currency introduction/trading (Prior Art) as illustrated in FIG. 1. In this figure, the FXRMP is shown with a central bank 40 withholding the individual currency trading ownership right to its currency (FXR (α, $)) 42 possessed by a central bank 40 prior to a currency's introduction, in order to allow a central bank 40 to prevent that currency, at introduction (or thereafter), from being bought excessively by speculators and investors for the purpose of driving that currency higher, while all of the other currency trading rights within the bundle possessed by the central bank 40 prior to introduction (FXR (α . . . η, $))-(FXR (α, $)) 43 are sold to purchasers 41 of the currency as currency trading rights packages for full use by a currency purchaser 40 to maximize the utility of the currency held in the global financial marketplace, in accordance with the principles of the present invention.

By withholding the currency trading ownership right to lend (FXR (α, $)) 42 prior to currency introduction, the central bank 40 has effectively precluded excessive buying of its currency, either by the initial purchaser 41 or, by subsequent purchasers 41; it cannot be sourced and bought by a speculator or investor for the purpose of driving it higher. The central bank 40 has effectively prevented excessive buying of its currency, making it safer for long-term investors to purchase and hold, because the currency will not be available for those looking to buy it as a speculative investment or as a hedge against derivative instruments bought/sold on the underlying currency. Furthermore, by precluding speculators and investors from purchasing the currency 43, speculators and investors cannot pressure a central bank's currency in order to make it more expensive for a central bank/government to raise/borrow new capital for economic growth or to hurt the country's domestic economy.

As illustrated in FIG. 6E, the implementation of the Foreign Exchange Rights Management Process (FXRMP) of FIG. 5A is shown incorporating the FXRMP Data Center 12, a central bank 40, banks and/or investment 11, various currency-purchasing entities (individuals, hedge funds, mutual funds, pension funds, insurers, endowments, municipalities, governments, sovereign wealth funds and exchange-traded funds) 13, various regulatory agencies, including the central banks and international and federal regulators, and, finally, the various currency markets and exchanges 14. Each of the aforementioned participants is linked to the others via various communications networks and via the Internet 15.

As shown in FIG. 6E, a central bank 40 hires a bank or investment bank firm (investment bank, etc.) 11, utilizing the FXRMP Data Center 12 of FIG. 4, to help structure the central bank's currency trading right(s) package in order to allow the central bank to maintain the currency trading ownership right (FXR (α, $)) 42. The bank or investment bank 11 structures the central bank's 40 new currency trading right(s) package 43 and, at the instruction of the central bank 40, incorporates the system and method of the present invention, whereby the bank or investment bank 11 recognizes that a currency consists of a bundle of currency trading rights (FXR (α . . . η, $)) 42 & 43, which can be unbundled, separated, and recombined into an individual, saleable package of currency trading rights. From this bundle of currency trading rights, the currency trading ownership right (FXR (α, $)) 42 is withheld prior to structuring and sale of the currency trading right(s) package in order to allow a central bank 40 to either preclude or control excessive purchasing of its currency in the global financial marketplace.

The bank or investment bank 11 structures the central bank's 40 currency trading right(s) package so that the central bank withholds the currency trading ownership right to its currency (FXR (α, $)) 42 prior to sale of the new currency trading right(s) package 43, which now is represented by the equation (FXR (α . . . η, $))-(FXR (α, $)) 43. The central bank or investment bank 11 then offers for purchase the central bank's 40 new currency trading right(s) package 43 to a broad array of investors including: individuals, hedge funds, managed futures funds, pension funds, insurers, endowments, mutual funds, governments, sovereign wealth funds and exchange-traded funds 13. These investors pay the bank or investment bank 11 for their currency trading right(s) packages 43, and the bank or investment bank 11 forwards the proceeds of the offering to the central bank 40 less any previously agreed commission for the bank's/investment bank's services. The central bank 40, the bank or investment bank 11 and, in some cases, various of the currency trading right(s) package purchasing entities 13, report all facets of the currency trading right(s) package's structure, offering terms, sale and purchases to the various regulatory agencies 14 as represented in FIG. 6E.

The central bank 40 has now issued a new currency trading right(s) package 43 and raised new capital but has withheld from the purchasers 13 the currency trading ownership right (FXR (α, $)) 42 to this currency for the purposes of buying this currency, as speculators and investors cannot purchase this currency from the purchasers of the newly-structured currency trading right(s) packages 43 for the purpose of driving the currency higher. Furthermore, it will be much harder for speculators and investors to purchase bullish derivative instruments on the central bank's 40 newly-structured currency trading right(s) packages 43, as the potential sellers of those bullish derivative instruments will be unable to purchase the central bank's 40 newly-structured currency trading right(s) packages 43 in an effort to hedge their sales of the bullish derivative instruments. The central bank 40 has also effectively precluded leveraged, bullish exchange-traded funds (ETF's) from including the new currency trading right(s) package 43 in their funds, as the ETF's are also precluded from purchasing the currency to drive it higher. Holders of the central bank's 40 new currency trading right(s) package 43 enjoy all of the benefits (currency trading rights) of normal currency ownership, except that they cannot lend the new currency trading right(s) package 43 to investors and speculators for the purpose of buying the currency to drive it higher.

As indicated at Block A in FIG. 6F, the central bank hires a bank or investment bank, utilizing the FXRMP of FIG. 5A, for the purpose of structuring and issuing a new currency trading right(s) package to withhold the currency trading right to lend (FXR (α, $)) the currency. At Block B, the bank or investment bank firm structures the central bank's currency trading right(s) package by withholding/excluding from the new currency trading right(s) package the currency trading ownership right (FXR (ζ, $)) from the central bank's new currency trading right(s) package, which is retained by the central bank. At Block C, the bank or investment bank then issues the central bank's new currency trading right(s) package ((FXR (α . . . η, $)-(FXR (α, $)), to its network of investors and speculators. At Block D, the investors and speculators pay for the central bank's new currency trading right(s) package, and the bank or investment bank delivers the proceeds from sale of the new currency trading right(s) offering to the central bank, less any fees/commissions; the currency trading right to lend (FXR (α, $)) the new currency trading right(s) package has been withheld and retained by the central bank. At Block E, all parties report required transactions to the various currency regulators and currency markets and exchange(s).

### FXRMP Network of the Present Invention Supporting A Non-Borrowable (Non-Shortable) or a Non-Purchasable (Non-Ownable) Currency Exchange

As illustrated in FIG. 7, the non-borrowable (non-shortable) currency exchange is shown, wherein central banks that have issued currency trading right(s) packages and have withheld currency trading right to lend (FXR (ζ, $)) those currencies 42, via the FXRMP 12, have listed their currency trading right(s) packages 16 (“U.S. Dollar/L” is an example of these “long-only” currencies). As these currency trading right(s) packages, designated by the “L” after their normal currency symbol/name for “long-only”, cannot be lent by the owner/holder of these currency trading right(s) packages to other investors, hedgers and/or speculators 13 for the purpose of selling the currencies short, these currency trading right(s) packages 16 cannot be sold short.

Similarly, these currency trading right(s) packages are not subject to naked-shorting, as they trade on a “Long-Only Security Exchange” 77, and the “L” in each currency trading right(s) package symbol/name designates it as a “long-only” currency trading right(s) package, as the currency trading right to lend (FXR (ζ, $)) 42 has been withheld from the currency trading right(s) package 43 prior to sale/production, leaving the subset of currency trading rights (FXR (α . . . η, $)) 43-(FXR (ζ, $)) 42 with the new currency trading right(s) package.

Most importantly, as shown in FIG. 7, all trades by market participants (individuals, hedge funds, managed futures funds, mutual funds, pension funds, insurers, endowments, governments, sovereign wealth funds, exchange-traded funds and others) 13 are conducted via various currency accounts held at the market participants' banks and investment banks 11 (Long-Only Security Exchange 77 Members). As such, the banks and investment banks 11 have access to the market participants' positions and can assure that only currency trading right(s) packages 16 already held by a market participant can be sold into the market, further precluding short sales of any type. In the event that market participants 13 (hedge funds and other speculators and investors) are concerned about secrecy of their trading, they can sell the “long-only” currency trading right(s) packages with a bank or investment bank other than that where they hold their “long-only” currency trading right(s) packages, as long as proper netting agreements are in place—these will also serve to assure that only currency trading right(s) packages already owned/held can be sold.

As with other currency markets and exchanges, all relevant transactions are reported to the various regulatory agencies 14 and monitored by the same.

As illustrated in FIG. 7A, the non-purchasable (non-ownable) currency exchange is shown, wherein central banks that have issued currency trading right(s) packages (FXR (α . . . η, $)) 43-(FXR (α, $)) and have withheld currency trading ownership right (FXR (α, $)) to those currencies 42, via the FXRMP 12, have listed their currency trading right(s) packages 16 (“U.S. Dollar/NP” is an example of these “non-purchasable” currencies). As these currency trading right(s) packages, designated by the “NP” after their normal currency symbol/name for “non-purchasable”, cannot be purchased by the owner/holder of these currency trading right(s) packages or by other investors, hedgers and/or speculators 13 for the purpose of driving those currencies higher.

Most importantly, as shown in FIG. 7A, all trades by market participants (individuals, hedge funds, managed futures funds, mutual funds, pension funds, insurers, endowments, governments, sovereign wealth funds, exchange-traded funds and others) 13 are conducted via various currency accounts held at the market participants' banks and investment banks 11 (Non-Purchasable Security Exchange 77 Members). As such, the banks and investment banks 11 have access to the market participants' positions and can assure that only currency trading right(s) packages 16 already held by a market participant will allow them then to lease or purchase the currency trading ownership right from a central bank, allowing them to purchase the central bank's currency in the market. In the event that market participants 13 (hedge funds and other speculators and investors) are concerned about secrecy of their trading, they can purchase the “non-purchasable” currency trading right(s) packages with a bank or investment bank other than that where they hold their “non-purchasable” currency trading right(s) packages, as long as proper netting agreements are in place—these will also serve to assure that only currency trading right(s) packages already owned/held can be used to lease or purchase the currency trading ownership right from the central bank.

As with other currency markets and exchanges, all relevant transactions are reported to the various regulatory agencies 14 and monitored by the same.

FIGS. 7B and 7C show two alternative implementations of the enterprise-level FXRMP Data Center 12 using the WebObjects® IDE and Java Application Server 21, 22, 29, 30, although it is understood that IDE's and server technology platforms can be used to implement and deploy server components of the COPRMP Data Center 12.

FIG. 7D is a flow chart depicting the non-borrowable (non-shortable) currency exchange and network of FIG. 7. As indicated at Block A, central banks that have sold and/or converted, their currencies into non-shortable/non-borrowable currency trading right(s) packages via the FXRMP, list their currency trading right(s) packages on the Long-Only Currency Exchange. At Block B, investment institutions and entities then purchase the non-shortable/non-borrowable listed currency trading right(s) packages via a currency brokerage firm (bank or investment bank) that holds member status on the Long-Only Currency Exchange. Finally, at Block C, the investment institutions and entities, along with the currency brokerage firm(s), report all pertinent transactions on the Long-Only Currency Exchange to the proper regulatory agencies.

FIG. 7E is a flow chart depicting the non-purchasable (non-ownable) currency exchange and network of FIG. 7A. As indicated at Block A, central banks that have sold and/or converted, their currencies into non-purchasable/non-ownable currency trading right(s) packages via the FXRMP, list their currency trading right(s) packages on the Non-Purchasable Currency Exchange. At Block B, investment institutions and entities then purchase the non-purchasable/non-ownable listed currency trading right(s) packages via a currency brokerage firm (bank or investment bank) that holds member status on the Non-Purchasable Currency Exchange. Finally, at Block C, the investment institutions and entities, along with the currency brokerage firm(s), report all pertinent transactions on the Non-Purchasable Currency Exchange to the proper regulatory agencies.

### FXRMP Network of the Present Invention Supporting Currency Conversion Process

As is illustrated in FIG. 8, the FXRMP currency conversion process of the present invention allows central banks 16 to convert already sold/introduced currencies, which can be borrowed and sold short, into currency trading right(s) packages by withholding the currency trading right to lend (FXR (ζ, $)), creating “long-only” currencies, which cannot be borrowed/sold-short, by employing the FXRMP Data Center 12 of FIG. 4. This can be done only by central bank that controls its currency.

A central bank employs a bank or investment bank 11 to convert its currency into a “long-only” currency by withholding the currency trading right to lend (FXR (ζ, $)). Through the conversion process, the central bank 16 hires a bank or investment bank 11 utilizing the FXRMP Data Center 12 of FIG. 4, to withhold and retain the currency trading right to lend (FXR (ζ, $)) from a new currency trading right(s) package consisting of (FXR (α . . . η, $, $))-(FXR (ζ, $)), precluding the new currency trading right(s) package from being lent to speculators, investors and/or hedgers for the purpose of selling it short and betting against the fortunes of the central bank/country.

Once the notice of conversion has been sent (and approval received, if needed), the central bank 16 enlists the services of one or more banks or investment banks 11 to complete the currency conversion process. The investment bank(s) 11 utilize(s) the system and methods of the FXRMP 12 of the present invention to restructure and reissue the new currency trading right(s) packages, (FXR (α . . . η, $))-(FXR (ζ, $)), pursuant to the central bank's 16 desires which, in the example shown in FIG. 8, involve the central bank 16 withholding either the currency trading right to lend (FXR (ζ, $)) or other currency trading right(s) from the new currency trading right(s) package.

Once restructured and reissued by the investment bank(s) 11, the central bank 16 using the system and methods of the FXRMP Data Center 12 of FIG. 4, has effectively precluded from short-selling the now “long-only” currency, which, in this example, are designated by an “L” following the currency's standard symbol/name, by speculators, investors and/or hedgers.

All parties report required transactions and information to the relevant regulatory agencies and to the proper currency markets and exchange(s) 14.

As is illustrated in FIG. 8A, the FXRMP currency conversion process of the present invention allows central banks 16 to convert already sold/introduced currencies, which can be purchased, into currency trading right(s) packages by withholding the currency trading ownership right (FXR (α, $)), creating “non-purchasable” currencies, which cannot be bought, by employing the FXRMP Data Center 12 of FIG. 4. This can be done only by central bank that controls its currency.

A central bank employs a bank or investment bank 11 to convert its currency into a “non-purchasable” currency by withholding the currency trading ownership right (FXR (α, $)). Through the conversion process, the central bank 16 hires a bank or investment bank 11 utilizing the FXRMP Data Center 12 of FIG. 4, to withhold and retain the currency trading ownership right (FXR (α, $)) from a new currency trading right(s) package consisting of (FXR (α . . . η, $))-(FXR (α, $)), precluding the new currency trading right(s) package from being bought by speculators, investors and/or hedgers for the purpose of driving the central bank's currency higher and betting against the fortunes of the central bank/country.

Once the notice of conversion has been sent (and approval received, if needed), the central bank 16 enlists the services of one or more banks or investment banks 11 to complete the currency conversion process. The investment bank(s) 11 utilize(s) the system and methods of the FXRMP 12 of the present invention to restructure and reissue the new currency trading right(s) packages, (FXR (α . . . η, $))-(FXR (α, $)), pursuant to the central bank's 16 desires which, in the example shown in FIG. 8A, involve the central bank 16 withholding either the currency trading ownership right (FXR (α, $)) or other currency trading right(s) from the new currency trading right(s) package.

Once restructured and reissued by the investment bank(s) 11, the central bank 16 using the system and methods of the FXRMP Data Center 12 of FIG. 4, has effectively precluded from purchasing the now “non-purchasable” currency, which, in this example, are designated by an “NP” following the currency's standard symbol/name, by speculators, investors and/or hedgers.

All parties report required transactions and information to the relevant regulatory agencies and to the proper currency markets and exchange(s) 14.

FIGS. 8B and 8C show two alternative implementations of the enterprise-level FXRMP Data Center 12 of FIG. 4 using the WebObjects® IDE and Java Application Server 21, 22, 29, 30, although it is understood that IDE's and server technology platforms can be used to implement and deploy server components of the FXRMP Data Center 12.

FIG. 8D is a flow chart depicting the FXRMP Currency Conversion Process of FIG. 8. As indicated in Block A of FIG. 8D, a central bank hires a bank or investment bank to restructure its currency from a standard currency into a long-only currency trading right(s) package. At Block B, the bank or investment bank restructures the currency, using the system and methods of the present invention (FXRMP), and separates, and withholds, from the set of currency trading rights restructured into a currency trading right(s) package, the currency trading right to lend (FXR (ζ, $))—the central bank retains the currency trading right to lend its currency. At Block C, the bank or investment bank either returns the new currency trading right(s) package (FR (α . . . η, $, $))-(FXR (ζ, $)) or offers it to purchasers in the marketplace, and returns the currency trading right to lend (FXR (ζ, $)), to the central bank. The central bank can then lease or sell the currency trading right to lend (FXR (ζ, $)) to currency borrowers for the purpose of selling short the currency. At Block D, all parties report required transactions to the various currency regulators and currency markets and exchange(s).

FIG. 8E is a flow chart depicting the FXRMP Currency Conversion Process of FIG. 8A. As indicated in Block A of FIG. 8E, a central bank hires a bank or investment bank to restructure its currency from a standard currency into a “non-purchasable” currency trading right(s) package. At Block B, the bank or investment bank restructures the currency, using the system and methods of the present invention (FXRMP), and separates, and withholds, from the set of currency trading rights restructured into a currency trading right(s) package, the currency trading ownership right (FXR (α, $))—the central bank retains the currency trading ownership right to lend its currency. At Block C, the bank or investment bank either returns the new currency trading right(s) package (FR (α . . . η, $))-(FXR (α, $)) or offers it to purchasers in the marketplace, and returns the currency trading ownership right (FXR (α, $)), to the central bank. The central bank can then lease or sell the currency trading ownership right (FXR (α, $)) to currency trading rights packages buyers for the purpose of buying the currency. At Block D, all parties report required transactions to the various currency regulators and currency markets and exchange(s).

### FXRMP Network of The Present Invention Supporting A Central Bank-Controlled Currency Rights Management Exchange

As shown in FIG. 9, the FXRMP Central Bank-Controlled Currency Trading Rights Management Exchange (Non-Borrowable Currency) of the present invention allows central banks 16 to control the process through which their currencies can be sold short, taking control of the short-selling process out of the hands of investors, speculators, hedgers, brokerage firms and others 13, and allowing central banks, to assert their ability to control, manage, and profit from, the short-selling process of their own currencies; the FXRMP Data Center 12 allows central banks 16 to turn the shorting process on its head by controlling and charging for the ability to short their currencies. This exchange differs from that shown in FIG. 7 77, as it allows central banks 16 that have withheld the currency trading right to lend their currencies to profit by leasing those rights to potential short-sellers 13.

In the example shown in FIG. 9, a central bank 16 has withheld prior to sale, the currency trading right to lend (FXR (ζ, $)) its currency. This allows a central bank to control completely the process required to short its currency, as now any party interested in selling short the currency must agree to terms set by the central bank to borrow it to sell it short.

Through the FXRMP Data Center 12, the central bank sets the various criteria for shorting its currency. The central bank sets the lease (or purchase) rates (can vary by type of currency), lease periods, determines the amount of total currency right(s) supply to offer for short-selling, and sets any other parameters deemed important for leasing (or selling) the currency trading right to lend its currency.

Investors, speculators, hedgers, brokerage firms and others 13 then approach the FXRMP Data Center 12 of the present invention, via the Internet 15 or other methods of communication, to ascertain the various terms on which they can short various central banks' currencies. If one of the aforementioned parties agrees to the terms set by a central bank for shorting its currency, that party then remits the required money to lease (or purchase) the currency trading right to lend (FXR (ζ, $)) to the FXRMP Data Center 12, which distributes the money directly to the central bank. This is an important process, as it allows a short-seller to maintain complete anonymity, which is something short-sellers complain about when regulations are proposed to make their processes more transparent; they argue that if a central bank knows that they have shorted, or are interested in shorting, the central bank's currency, that central bank will not be forthcoming with information, etc. The FXRMP Data Center 12 allows short-sellers to lease (or purchase) the currency trading right to lend a currency, via the FXRMP Data Center 12, from the central bank, on the central bank's terms, but with total anonymity. More importantly, the FXRMP Data Center 12 allows the central bank to manage the entire currency short-selling process and profit from it directly.

Because all of the short-selling transactions for the currency trading right(s) package go through the FXRMP Data Center 12, it completely precludes naked short-selling, as the FXRMP Data Center 12 is able to allocate the currency trading right to lend (FXR (ζ, $)) for the central bank's currency based on the central bank's pre-specified criteria.

All transactions are reported, as required to the various regulatory agencies 14.

As shown in FIG. 9A, the FXRMP Central Bank-Controlled Currency Trading Rights Management Exchange (Non-Purchasable Currency) of the present invention allows central banks 16 to control the process through which their currencies can be bought, taking control of the buying process out of the hands of investors, speculators, hedgers, brokerage firms and others 13, and allowing central banks, to assert their ability to control, manage, and profit from excessive purchasing of their own currencies; the FXRMP Data Center 12 allows central banks 16 to turn the buying process on its head by controlling and charging for the ability to purchase their currencies. This exchange differs from that shown in FIG. 7A 77, as it allows central banks 16 that have withheld the currency trading ownership right to their currencies to profit by leasing or selling that right to potential currency purchasers 13.

In the example shown in FIG. 9A, a central bank 16 has withheld prior to sale, the currency trading ownership right to (FXR (α, $)) its currency. This allows a central bank to control completely the process required to purchase its currency, as now any party interested in buying the currency must agree to terms set by the central bank to purchase it to own it.

Through the FXRMP Data Center 12, the central bank sets the various criteria for purchasing its currency. The central bank sets the lease (or purchase) rates (can vary by type of currency), lease periods, determines the amount of total currency right(s) supply to offer for purchasing, and sets any other parameters deemed important for leasing (or selling) the currency trading ownership right to its currency.

Investors, speculators, hedgers, brokerage firms and others 13 then approach the FXRMP Data Center 12 of the present invention, via the Internet 15 or other methods of communication, to ascertain the various terms on which they can purchase various central banks' currencies. If one of the aforementioned parties agrees to the terms set by a central bank for purchasing its currency, that party then remits the required money to lease (or purchase) the currency trading ownership right (FXR (α, $)) to the FXRMP Data Center 12, which distributes the money directly to the central bank. This is an important process, as it allows a currency purchaser to maintain complete anonymity, which is something speculators and investors complain about when regulations are proposed to make their processes more transparent; they argue that if a central bank knows that they have bought, or are interested in buying, the central bank's currency, that central bank will not be forthcoming with information, etc. The FXRMP Data Center 12 allows purchasers to lease (or purchase) the currency trading ownership right to a currency, via the FXRMP Data Center 12, from the central bank, on the central bank's terms, but with total anonymity. More importantly, the FXRMP Data Center 12 allows the central bank to manage the entire currency purchasing process and profit from it directly.

Because all of the purchasing transactions for the currency trading right(s) package go through the FXRMP Data Center 12, it completely precludes excessive currency buying, as the FXRMP Data Center 12 is able to allocate the currency trading ownership right (FXR (α, $)) for the central bank's currency based on the central bank's pre-specified criteria.

All transactions are reported, as required to the various regulatory agencies 14.

FIGS. 9B and 9C show two alternative implementations of the enterprise-level FXRMP Data Center 13 of FIG. 9 using the WebObjects® IDE and Java Application Server 21, 22, 29, 30, although it is understood that IDE's and server technology platforms can be used to implement and deploy server components of the FXRMP Data Center 12.

FIG. 9D is a flow chart depicting the various steps of the FXRMP Central Bank-Controlled Currency Trading Rights Management Exchange (Non-Borrowable Currency) depicted in FIG. 9. As indicated at Block A of FIG. 9D, a central bank has either withheld the currency trading right to lend its currency (FXR (ζ, $)) prior to issuance of a currency trading right(s) package consisting of (FXR (α . . . η, $))-(FXR (ζ, $)), or has converted its outstanding currency to withhold the currency trading right to lend (FXR (ζ, $)), so that it holds the currency trading right to lend its currency.

At Block B, via the FXRMP, the central bank sets rates for investors, speculators, hedgers, brokerage firms, and others to lease (or purchase) the withheld/retained currency trading right to lend its currency (FXR (ζ, $)) at rates that seek to optimize profit for the central bank. The rate schedule may be set to escalate with increasing interest to short its currency. The central bank also can set limits on the amount of the currency trading lending right (FXR (ζ, $)) it offers to short sellers and, for the time that short sellers may hold these rights, by requiring the short sellers to re-lease the right(s) to lend on a periodic basis. The central bank controls the entire shorting process by setting the lease rates, which can vary by type of currency, that short sellers may short its currency. The central bank can also specify different lease rates, amounts and periods based on the type of short-seller and can exclude certain classes of short sellers pending regulatory approval.

At Block C, the various investors, speculators, hedgers, brokerage firms, and others express their interest to short the central bank's currency via the FXRMP, thus assuring that the short-sellers remain anonymous to the central bank. The short-seller(s) then remit(s) payment for leasing the currency trading right to lend (FXR (ζ, $)) from the central bank to the FXRMP based on the aforementioned fee schedule determined by the central bank.

At Block D, the FXRMP remits payment for the currency trading right to lend (FXR (ζ, $)) back to the central bank and reports, as required, all transactions to the proper regulatory authorities.

FIG. 9E is a flow chart depicting the various steps of the FXRMP Central Bank-Controlled Currency Trading Rights Management Exchange (Non-Purchasable Currency) depicted in FIG. 9A. As indicated at Block A of FIG. 9E, a central bank has either withheld the currency trading ownership right to its currency (FXR (α, $)) prior to issuance of a currency trading right(s) package consisting of (FXR (α . . . η, $))-(FXR (α, $)), or has converted its outstanding currency to withhold the currency trading ownership right (FXR (α, $)), so that it holds the currency trading ownership right to its currency.

At Block B, via the FXRMP, the central bank sets rates for investors, speculators, hedgers, brokerage firms, and others to lease (or purchase) the withheld/retained currency trading ownership right to its currency (FXR (α, $)) at rates that seek to optimize profit for the central bank. The rate schedule may be set to escalate with increasing interest to purchase its currency. The central bank also can set limits on the amount of the currency trading ownership right (FXR (α, $)) it offers to currency purchasers and, for the time that purchasers may hold these rights, by requiring the currency purchaser to re-lease the ownership right(s) on a periodic basis. The central bank controls the entire purchasing process by setting the lease rates, which can vary by type of currency, that currency purchasers may purchase its currency. The central bank can also specify different lease rates, amounts and periods based on the type of purchaser and can exclude certain classes of purchasers pending regulatory approval.

At Block C, the various investors, speculators, hedgers, brokerage firms, and others express their interest to purchase the central bank's currency via the FXRMP, thus assuring that the purchasers remain anonymous to the central bank. The purchaser(s) then remit(s) payment for leasing the currency trading ownership right (FXR (α, $)) from the central bank to the FXRMP based on the aforementioned fee schedule determined by the central bank.

At Block D, the FXRMP remits payment for the currency trading ownership right (FXR (α, $)) back to the central bank and reports, as required, all transactions to the proper regulatory authorities.

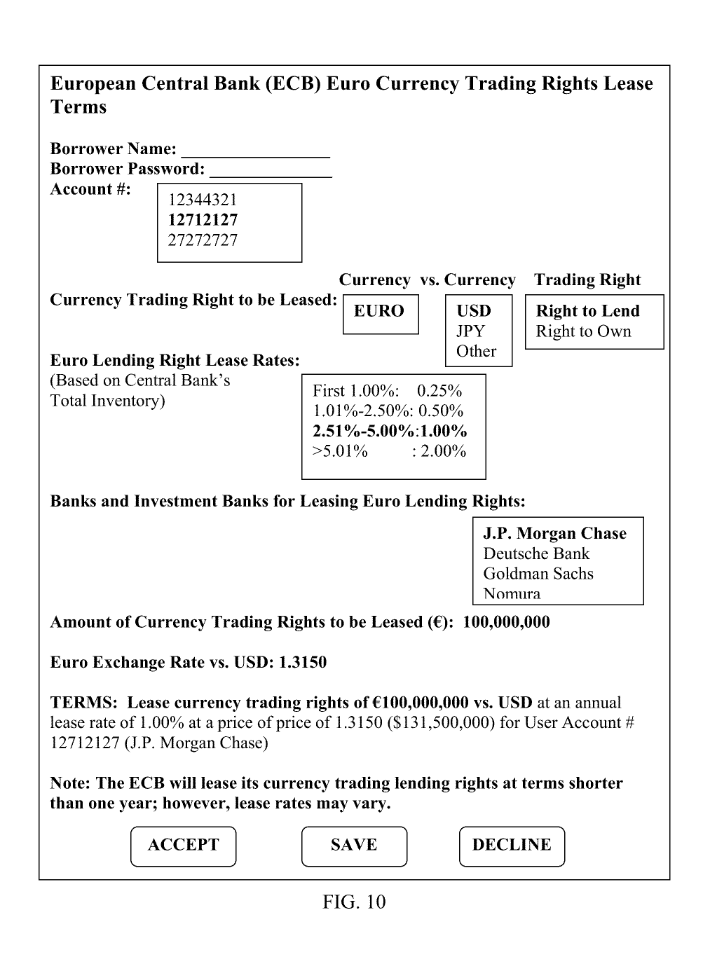

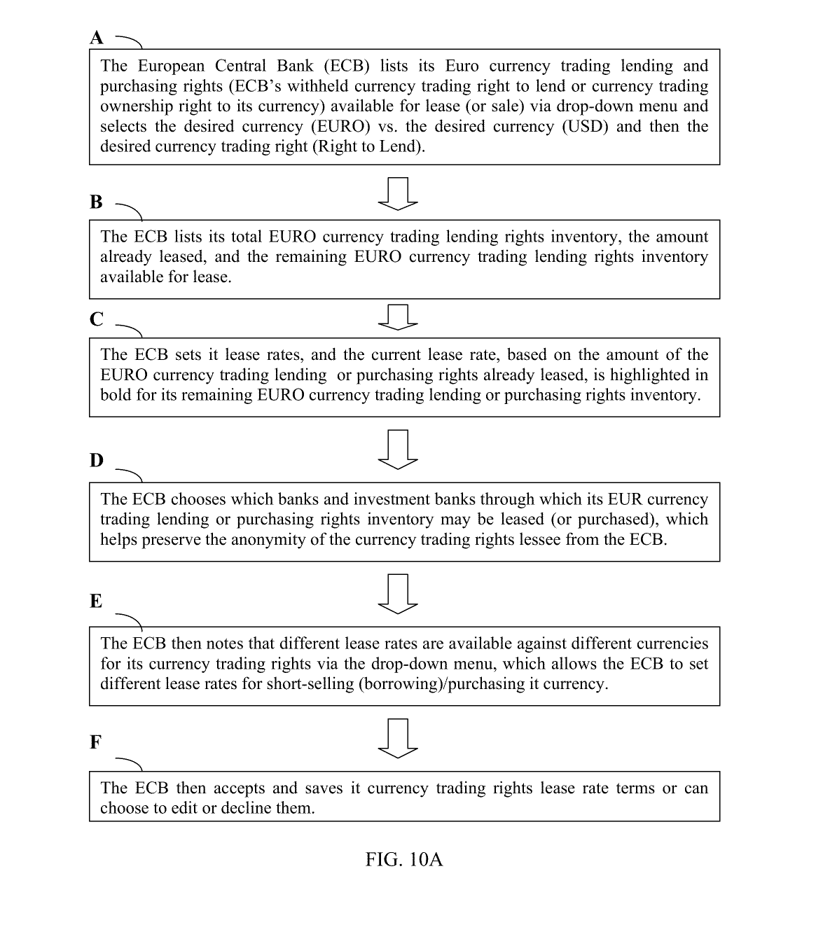

FIG. 10 is a FXRM Network Central Bank-Controlled Currency Trading Rights Management Exchange Process for Establishing Currency Trading Lending Rights or Currency Trading Ownership Rights Lease Rates graphical user interface (GUI) screen that allows a central bank to set the borrowing or purchasing terms for its currency and through which, a currency borrower or purchaser selects various accounts and terms from both from drop-down menus and by typing in pertinent information related to the borrowing or purchasing of a currency from the central bank via the system and methods of the present invention.

As shown in FIG. 10, a central bank accesses the its Web site to establish rates and terms for the currency borrowing or purchasing process.

The central bank securely logs-in to the site and then selects, via drop-down menu, from various accounts it has established to extend credit to the currency borrower or purchaser. After specifying the account(s) with which it will allow currency trading rights to be leased or purchased (the currency trading right to lend or currency trading ownership right), the central bank then selects the currency trading right to lease or to sell, in this case the Euro, from another drop-down menu, establishes the currency against which the Euro trades, in this case the USD, and establishes the currency trading right to be leased or purchased (in this case, the trading right to lend). It then sets the rates at which it may be leased or purchased and selects the bank(s) through which the chosen currency trading right can be leased or purchased.

Once the currency trading right to be leased or purchased has been selected, the central bank is then shown an example based on the current spot trading rate of the currency pair selected.

The central bank then selects, from three buttons at the bottom of the screen, whether to accept the terms it has established, save them for future reference, or decline them.

FIG. 10A is a flow chart depicting the various steps of the FXRM Network Central Bank-Controlled Currency Trading Rights Management Exchange Process for Establishing Currency Trading Lending Rights Lease Rates depicted in FIG. 10.

At Block A, The European Central Bank (ECB) lists its Euro currency trading lending and purchasing rights (ECB's withheld currency trading right to lend or currency trading ownership right to its currency) available for lease (or sale) via drop-down menu and selects the desired currency (EURO) vs. the desired currency (USD) and then the desired currency trading right (Right to Lend).

At Block B, the ECB lists its total EURO currency trading lending rights inventory, the amount already leased, and the remaining EURO currency trading lending rights inventory available for lease.

At Block C, the ECB sets it lease rates, and the current lease rate, based on the amount of the EURO currency trading lending or purchasing rights already leased, is highlighted in bold for its remaining EURO currency trading lending or purchasing rights inventory.

At Block D, the ECB chooses which banks and investment banks through which its EUR currency trading lending or purchasing rights inventory may be leased (or purchased), which helps preserve the anonymity of the currency trading rights lessee from the ECB.

At Block E, the ECB then notes that different lease rates are available against different currencies for its currency trading rights via the drop-down menu, which allows the ECB to set different lease rates for short-selling (borrowing)/purchasing it currency. Finally, at Block F, the ECB then accepts and saves it currency trading rights lease rate terms or can choose to edit or decline them.

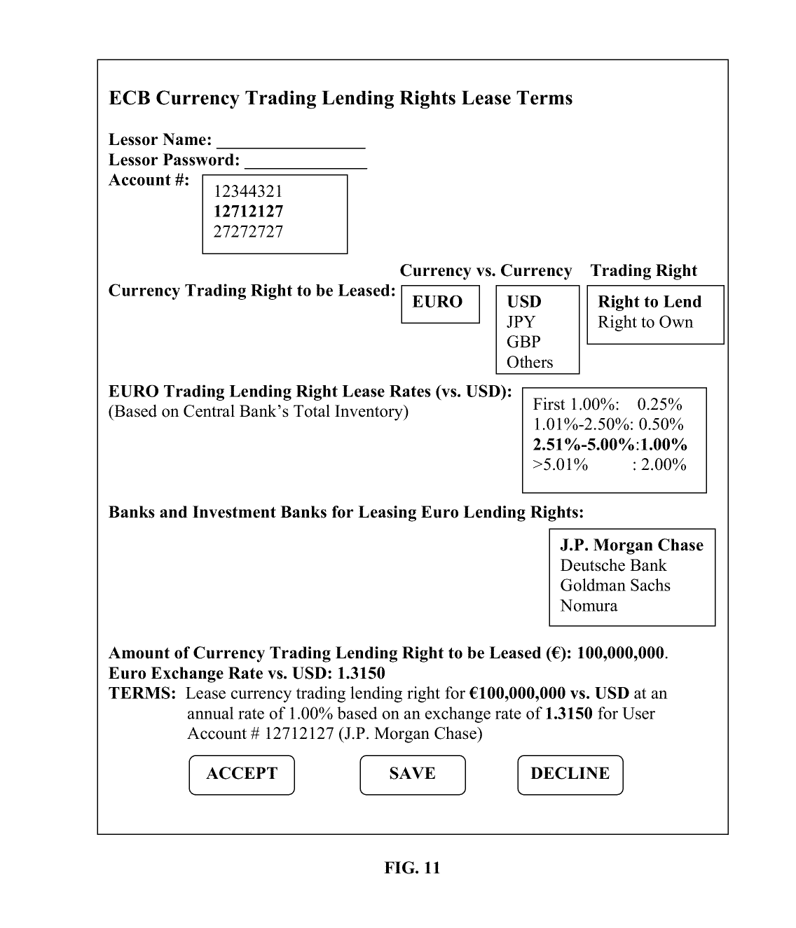

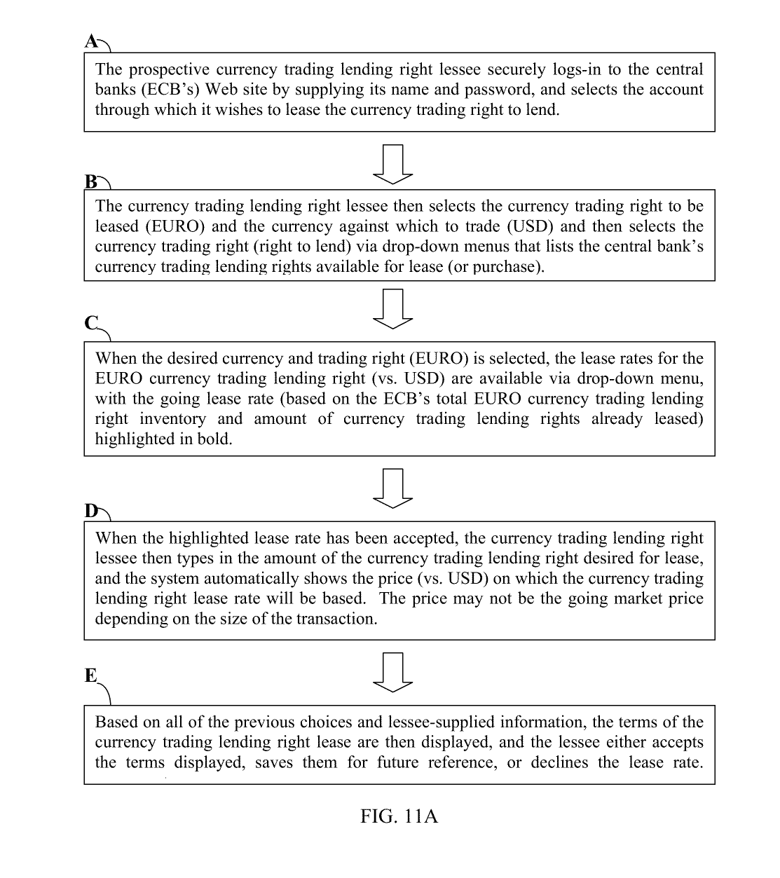

FIG. 11 shows the FXRM Network Central Bank-Controlled Rights Management Exchange Process for Currency Trading Lending Rights Lessees graphical user interface (GIU) screen through which a currency trading right lessee accesses central bank's Web site to initiate the currency trading lending rights lease process.

The prospective currency trading lending right(s) lessee securely logs-in to the site and then selects, via drop-down menu, from various accounts it has established directly with the central bank. After specifying the account(s) with which it will lease the currency trading lending right, the currency trading lending right lessee then selects the currency (EURO), the currency against which the Euro will trade (USD) and the currency trading lending right(s) it wishes to lease, in this case the central bank's (ECB) EURO currency trading lending right, from another drop-down menu.

Once the currency trading lending right to be leased has been selected, the currency trading lending right lessee is then shown, via drop-down menu, the terms at which it may lease the central bank's currency trading lending right(s). This is based on the central bank's entire EURO currency trading lending rights inventory and is shown as an escalating lease scale, where the first 1.00% of the central bank's EURO currency lending right inventory may be borrowed at 0.25% per annum, the next 1.01-2.50% at 0.50% per annum, the next 2.51-5.00% at 1.00% per annum and anything above 5.00% of the central bank's currency trading lending right inventory may be borrowed at 2.00% per annum.

The currency trading lending right lessee then selects from the banks chosen by the central bank (in FIG. 10) to lease or sell its currency trading right to lend, and then types in the currency trading lending right amount, in the currency's normal denomination (in this case, EURO), it wishes to lease, and the system produces the real-time market price for the EURO (in this case vs. the U.S. Dollar) along with a summary of the terms at which the currency trading lending right lessee may lease the EURO currency trading lending right from the central bank.

The currency trading lending right lessee then selects, from three buttons at the bottom of the screen, whether to accept the terms of the central bank, save them for future reference, or decline them.

FIG. 11A is a flow chart depicting the various steps carried out during the FXRM Network Central Bank-Controlled Rights Management Exchange Process for Currency Trading Lending Rights Lessees on a graphical user interface (GUI) screen.

At Block A, the prospective currency trading lending right lessee securely logs-in to the central banks (ECB's) Web site by supplying its name and password, and selects the account through which it wishes to lease the currency trading right to lend.

At Block B, the currency trading lending right lessee then selects the currency trading right to be leased (EURO) and the currency against which to trade (USD) and then selects the currency trading right (right to lend) via drop-down menus that lists the central bank's currency trading lending rights available for lease (or purchase).

At Block C, when the desired currency and trading right (EURO) is selected, the lease rates for the EURO currency trading lending right (vs. USD) are available via drop-down menu, with the going lease rate (based on the ECB's total EURO currency trading lending right inventory and amount of currency trading lending rights already leased) highlighted in bold.

At Block D, when the highlighted lease rate has been accepted, the currency trading lending right lessee then types in the amount of the currency trading lending right desired for lease, and the system automatically shows the price (vs. USD) on which the currency trading lending right lease rate will be based. The price may not be the going market price depending on the size of the transaction.

At Block E, based on all of the previous choices and lessee-supplied information, the terms of the currency trading lending right lease are then displayed, and the lessee either accepts the terms displayed, saves them for future reference, or declines the lease rate.

FXRMP Network of The Present Invention Supporting A Central Bank-Controlled Currency Rights Management Exchange with Currency Trading Band Establishment

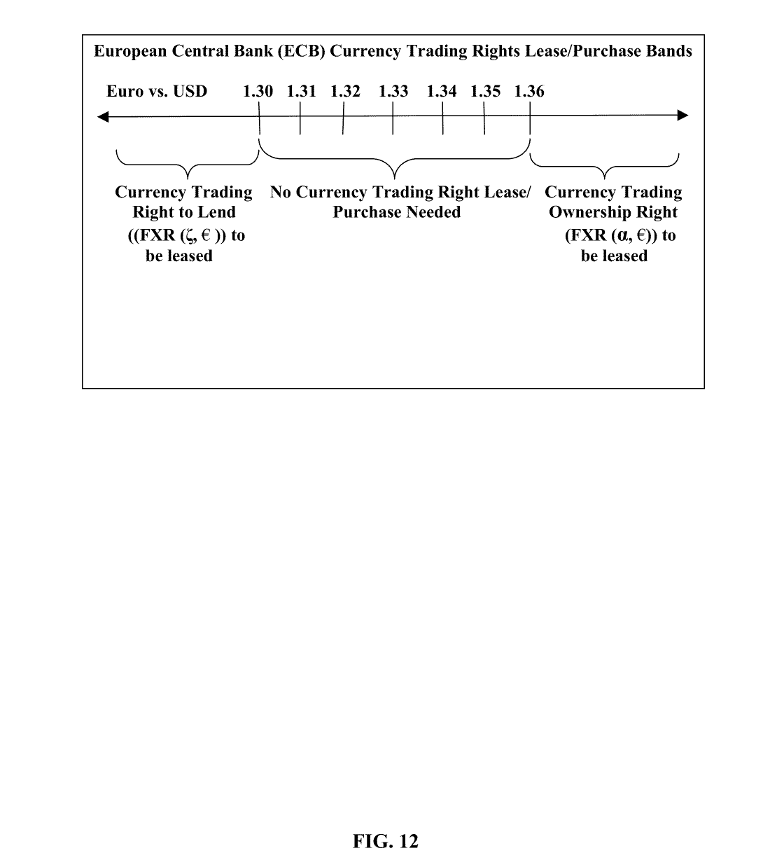

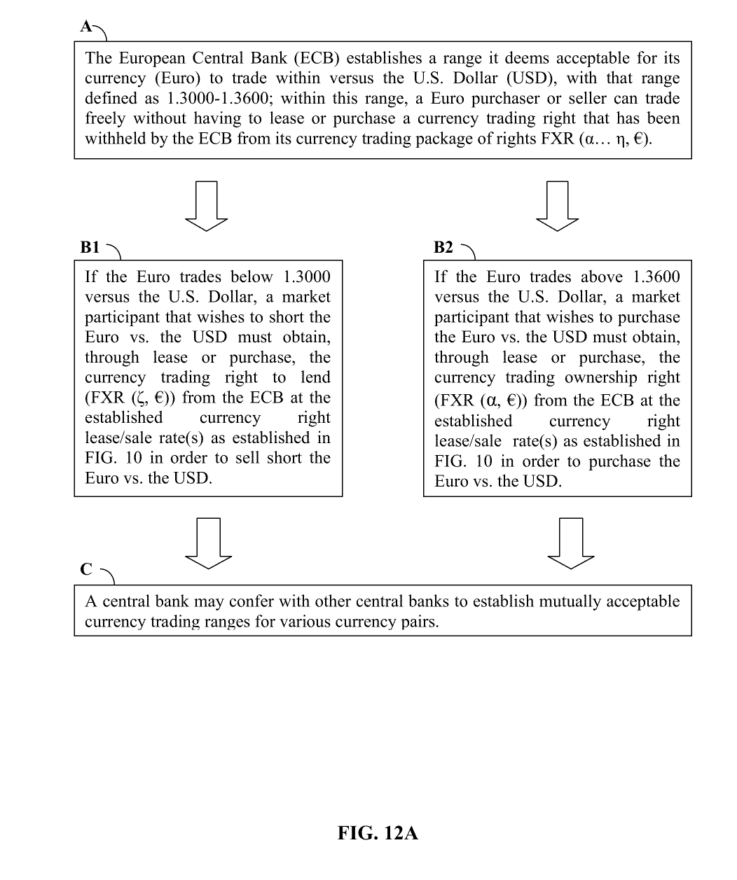

FIG. 12 is a FXRM Network Central Bank-Controlled Currency Trading Rights Management Exchange Process for Setting Currency Trading Rights Lease or Purchase Bands, which allows a central bank, in this example the European Central Bank (ECB) to establish a range within which, it is comfortable with its currency (Euro) trading vs. the U.S. Dollar (USD) (in this example, 1.3000-1.3600); outside of that range, below 1.3000, a prospective short seller would need to contact the ECB, via the process shown in FIG. 11, to lease (or purchase) the currency trading right to lend (FXR (ζ, ε)) in order to short the Euro vs. the USD, and above 1.3600, a prospective buyer of the Euro vs. the USD would need to lease (or purchase) the currency trading ownership right (FXR (α,ε)) in order to purchase the Euro vs. the USD.

In FIG. 12, the European Central Bank (ECB) establishes a range it deems acceptable for its currency (Euro) to trade within versus the U.S. Dollar (USD), with that range defined as 1.3000-1.3600; within this range, a Euro purchaser or seller can trade freely without having to lease or purchase a currency trading right that has been withheld by the ECB from its currency trading package of rights FXR (α . . . η, ε).

If the Euro trades below 1.3000 versus the U.S. Dollar, a market participant that wishes to short the Euro vs. the USD must obtain, through lease or purchase, the currency trading right to lend (FXR (ζ, ε)) from the ECB at the established currency right lease/sale rate(s) as established in FIG. 10.

If the Euro trades above 1.3600 versus the U.S. Dollar, a market participant that wishes to purchase the Euro vs. the USD must obtain, through lease or purchase, the currency trading ownership right (FXR (α,ε)) from the ECB at the established currency right lease/sale rate(s) as established in FIG. 10.

A central bank may confer with other central banks to establish mutually acceptable currency trading ranges for various currency pairs.

FIG. 12A is a flow chart depicting the various steps carried out during the FXRM Network Central Bank-Controlled Rights Management Exchange Process for Setting Currency Trading Rights Lease or Purchase Bands.

At Block A, a central bank, in this case, the European Central Bank (ECB), establishes a range it deems acceptable for its currency (Euro) to trade within versus the U.S. Dollar (USD), with that range defined as 1.3000-1.3600; within this range, a Euro purchaser or seller can trade freely without having to lease or purchase a currency trading right that has been withheld by the ECB from its currency trading package of rights FXR (α . . . η, ε).

At Block B1, if the Euro trades below 1.3000 versus the U.S. Dollar, a market participant that wishes to short the Euro vs. the USD must obtain, through lease or purchase, the currency trading right to lend (FXR (ζ, ε)) from the ECB at the established currency right lease/sale rate(s) as established in FIG. 10 in order to sell short the Euro vs. the USD.

At Block B2, if the Euro trades above 1.3600 versus the U.S. Dollar, a market participant that wishes to purchase the Euro vs. the USD must obtain, through lease or purchase, the currency trading ownership right (FXR (α, ε)) from the ECB at the established currency right lease/sale rate(s) as established in FIG. 10 in order to purchase the Euro vs. the USD.

At Block C, a central bank may confer with other central banks to establish mutually acceptable currency trading ranges for various currency pairs.

Also, it is understood that the illustrative embodiments may be modified in a variety of ways which will become readily apparent to those skilled in the art of having the benefit of the novel teachings disclosed herein. All such modifications and variations of the illustrative embodiments thereof shall be deemed to be within the scope and spirit of the present invention as defined by the Claims to Invention appended hereto.

1. A system for implementing a currency trading rights management process (FXRMP) over a distributed communications network, and deployed in a financial marketplace involving one or more central banks, one or more currency purchasers, one or more currency borrowers, said system comprising:
a data center, including one or more relational database servers (RDBMS), application servers, and web servers, interfaced with the infrastructure of said distributed communications network;
a first networked group of computer systems for use by said one or more said central banks, and being interfaced with the infrastructure of said distributed communications network, and including client machines and server machines, for supporting packet-based communications between said data center and said first networked group of computer systems;
a second networked group of computer systems for use by said one or more currency trading right(s) lessees or purchasers, and being interfaced with the infrastructure of said distributed communications network, and including client machines and server machines, for supporting packet-based communications between said data center and said second networked group of computer systems;
wherein said data center supports the implementation of a network-level financial accounting system that recognizes and accounts for a set of currency trading rights possessed by said central bank prior to issuance/sale, or after restructuring, and ensures that said set of currency trading rights is unbundled, separated into a plurality of individual currency trading rights (FXR (α . . . η, $)), including the currency trading right to lend (FXR (ζ, $)) and the currency trading ownership right (FXR (α, $)), and recombined into non-borrowable or non-purchasable currency rights packages that exclude the currency trading right to lend (FXR (ζ, $)) or the currency trading ownership right (FXR (α, $)) (and/or other currency trading rights) and which are offered for sale or lease in said financial marketplace; and
wherein said central bank (i) withholds from, and prior to, currency issuance/sale, or retains after restructuring, the currency trading right to lend (FXR (ζ, $)) or the currency trading ownership right (FXR (α, $)), to create said non-borrowable or non-purchasable currency trading right(s) package, which precludes lending and borrowing, or purchasing, of said non-borrowable or non-purchasable currency by said purchasers of said non-borrowable currency and, which, then can be leased or purchased only from said central bank holding the currency trading right to lend (FXR (ζ, $)) or the currency trading ownership right (FXR (α, $)) at lease or purchase rates set by said central bank, thereby precluding the lending of said non-borrowable currency or the purchasing of said non-purchasable currency by said currency purchasers or borrowers in said financial marketplace;
wherein said central bank uses said first networked group of computer systems to communicate with said data center via packet-based communications, to set lease or purchase rates and periods for said non-borrowable currency trading right(s) package held by said currency purchasers, and which can be leased or purchased by currency borrowers from said central bank only after procuring the currency trading right to lend (FXR (ζ, $)) from said central bank pursuant to agreement with said lease or purchase rates and periods;
wherein said central bank uses said first networked group of computer systems to communicate with said data center via packet-based communications, to set lease and purchase rates and periods for said non-purchasable currency trading right(s) package held by said currency purchasers, and which can be leased or purchased by currency borrowers from said central bank only after procuring the currency trading ownership right (FXR (α, $)) from said central bank pursuant to agreement with said lease or purchase rates and periods;
wherein said currency borrower or purchaser uses said second networked group of computer systems to communicate with said data center via packet communications, and (i) requests from said central bank, the currency trading right to lend (FXR (ζ, $)) or the currency trading ownership right (FXR (α, $)) for said non-borrowable or non-purchasable currency pursuant to said lease or purchase rates and periods set by said central bank, (ii) accepts said lease or purchase rates and periods set by said central bank, and (iii) receives said currency trading right to lend (FXR (ζ, $)) or currency trading ownership right (FXR (α, $)) associated with said non-borrowable or non-purchasable currency, from said central bank, via said data center, so that said currency borrower or purchaser can lease or purchase said currency trading right to lend (FXR (ζ, $)) or currency trading ownership right (FXR (α, $)) associated with said non-borrowable or non-purchasable currency from said central bank for the purpose of selling said non-borrowable currency short, or for the purpose of buying said non-purchasable currency, in said financial marketplace; and
wherein said data center automatically accounts for the allocation of said leased or purchased currency trading right to lend (FXR (ζ, $)), of said leased or purchased currency trading ownership right (FXR (α, $)) (and/or other currency trading rights) associated with said non-borrowable or non-purchasable currency, and payment of said lease or purchase rates agreed to between said central bank and said currency right lessee or purchaser.

2. The system of claim 1, wherein each said first and second group of networked computer systems comprises relational database servers (RDBMSs), application servers, and web servers, and client machines supporting graphical user interfaces (GUIs).

3. The system of claim 1, wherein said distributed communications network comprises the Internet supporting TCP/IP.

4. The system of claim 1, wherein said central bank comprises one or more central banks

5. The system of claim 1, wherein central banks are afforded the opportunity to withhold and/or transfer the currency trading right to lend (FXR (ζ, $)) or the currency trading ownership right (FXR (α, $)), which they possess prior to currency issuance/sale, or after restructuring, so as to optimize profit from, and to manage, the leasing/purchasing or currency rights and, thus, short-selling or purchasing of their currencies.

6. The system of claim 1, wherein central banks are afforded the opportunity to collect currency borrowing revenue from short-term or high-frequency traders, by requiring all currency borrowing to be sourced through the central banks that have withheld the currency trading right to lend ((FXR (ζ, $) or the currency trading ownership right (FXR (α, $)), which facilitates immediate location and borrowing or purchasing of said currencies.

7. The system of claim 1, which further comprises a third networked group of computer systems for use by government regulatory agencies, and being interfaced with the infrastructure of said distributed communications network, and including client machines and server machines, for supporting communications between said data center and said third networked group of computer systems; and wherein said government regulatory agencies use said third networked group of computer systems to communicate with said data center via packet-based communications, for the purpose of overseeing said central banks and said currency borrowers and purchasers in said financial marketplace.

8. The system of claim 1, wherein central banks are able to withhold, prior to issuance or sale, or after restructuring, the individual currency trading right to lend ((FXR (ζ, $), so as to preclude borrowing and, thus, short-selling of said currencies, or the individual currency trading ownership right (FXR (α, $)), so as to preclude the excessive purchasing of said currencies.

9. The system of claim 1, wherein said central banks are able to restructure existing, outstanding currencies to withhold the individual currency trading right to lend ((FXR (ζ, $), so as to preclude borrowing and, thus, short-selling of their currencies, or to withhold the individual currency trading ownership right (FXR (α, $)), so as to preclude excessive purchasing or their currencies.

10. The system of claim 1, whereby a long-only (non-borrowable) currency is created by a central bank by permanently withholding the currency trading right to lend ((FXR (ζ, $) prior to the issuance/sale of a currency or after a currency's restructuring.

11. The system of claim 1, whereby a non-purchasable currency is created by a central bank by permanently withholding the currency trading ownership right ((FXR (α, $) prior to the issuance/sale of a currency or after a currency's restructuring.

12. The system of claim 1, whereby a central bank establishes the lease or purchase rates for the currency trading right to lend ((FXR (ζ, $), the currency trading ownership right (FXR (α, $)), or other currency rights, which may be based on a number of different metrics.

13. The system of claim 1, whereby a central bank establishes, on its own or in concert with one or more central banks, an acceptable trading range for its currency versus another currency within which, it will not lease or sell individual currency trading rights, or subsets of its currency trading rights package, but will allow its currency to trade freely.

14. The system of claim 1, whereby a central bank establishes, on its own or in concert with one or more central banks, an acceptable trading range for its currency versus another currency outside of which, it will lease or sell individual currency trading rights, or subsets of its currency trading rights package.

15. The system of claim 1, wherein central banks establish currency trading ranges in which the central banks will share any income from leasing or selling individual currency trading rights.

16. A system for implementing a currency trading rights management process (FXRMP) over a distributed communications network, and deployed in a financial marketplace involving one or more central banks, one or more currency purchasers, one or more currency borrowers, said system comprising:
a data center, including one or more relational database servers (RDBMS), application servers, and web servers, interfaced with the infrastructure of said distributed communications network;
a first networked group of computer systems for use by said one or more said central banks, and being interfaced with the infrastructure of said distributed communications network, and including client machines and server machines, for supporting packet-based communications between said data center and said first networked group of computer systems;
a second networked group of computer systems for use by said one or more currency trading right(s) lessees or purchasers, and being interfaced with the infrastructure of said distributed communications network, and including client machines and server machines, for supporting packet-based communications between said data center and said second networked group of computer systems;
wherein said data center supports the implementation of a network-level financial accounting system that recognizes and accounts for a set of currency trading rights possessed by said central bank prior to issuance/sale, or after restructuring, and ensures that said set of currency trading rights is associated with non-borrowable or non-purchasable currency rights packages that exclude the currency trading right to lend (FXR (ζ, $)) or the currency trading ownership right (FXR (α, $)) (and/or other currency trading rights) and which are offered for sale or lease in said financial marketplace; and
wherein said central bank (i) withholds from, and prior to, currency issuance/sale, or retains after restructuring, the currency trading right to lend (FXR (ζ, $)) or the currency trading ownership right (FXR (α, $)), to create said non-borrowable or non-purchasable currency trading right(s) package, which precludes lending and borrowing, or purchasing, of said non-borrowable or non-purchasable currency by said purchasers of said non-borrowable currency and, which, then can be leased or purchased only from said central bank holding the currency trading right to lend (FXR (ζ, $)) or the currency trading ownership right (FXR (α, $)) at lease or purchase rates set by said central bank, thereby precluding the lending of said non-borrowable currency or the purchasing of said non-purchasable currency by said currency purchasers or borrowers in said financial marketplace;
wherein said central bank uses said first networked group of computer systems to communicate with said data center via packet-based communications, to set lease or purchase rates and periods for said non-borrowable currency trading right(s) package held by said currency purchasers, and which can be leased or purchased by currency borrowers from said central bank only after procuring the currency trading right to lend (FXR (ζ, $)) from said central bank pursuant to agreement with said lease or purchase rates and periods;
wherein said central bank uses said first networked group of computer systems to communicate with said data center via packet-based communications, to set lease and purchase rates and periods for said non-purchasable currency trading right(s) package held by said currency purchasers;
wherein said currency borrower or purchaser uses said second networked group of computer systems to communicate with said data center via packet communications, and (i) requests from said central bank, the currency trading right to lend (FXR (ζ, $)) or the currency trading ownership right (FXR (α, $)) for said non-borrowable or non-purchasable currency pursuant to said lease or purchase rates and periods set by said central bank, (ii) accepts said lease or purchase rates and periods set by said central bank, and (iii) receives said currency trading right to lend (FXR (ζ, $)) or currency trading ownership right (FXR (α, $)) associated with said non-borrowable or non-purchasable currency, from said central bank, via said data center, so that said currency borrower or purchaser can lease or purchase said currency trading right to lend (FXR (ζ, $)) or currency trading ownership right (FXR (α, $)) associated with said non-borrowable or non-purchasable currency from said central bank for the purpose of selling said non-borrowable currency short, or for the purpose of buying said non-purchasable currency, in said financial marketplace; and
wherein said data center automatically accounts for the allocation of said leased or purchased currency trading right to lend (FXR (ζ, $)), of said leased or purchased currency trading ownership right (FXR (α, $)) (and/or other currency trading rights) associated with said non-borrowable or non-purchasable currency, and payment of said lease or purchase rates agreed to between said central bank and said currency right lessee or purchaser.

17. The system of claim 16, wherein each said first and second group of networked computer systems comprises relational database servers (RDBMSs), application servers, and web servers, and client machines supporting graphical user interfaces (GUIs).

18. The system of claim 16, wherein said distributed communications network comprises the Internet supporting TCP/IP.

19. The system of claim 16, wherein said central bank comprises one or more central banks

20. The system of claim 16, wherein central banks are afforded the opportunity to withhold and/or transfer the currency trading right to lend (FXR (ζ, $)) or the currency trading ownership right (FXR (α, $)), which they possess prior to currency issuance/sale, or after restructuring, so as to optimize profit from, and to manage, the leasing/purchasing or currency rights and, thus, short-selling or purchasing of their currencies.

21. The system of claim 16, wherein central banks are afforded the opportunity to collect currency borrowing revenue from short-term or high-frequency traders, by requiring all currency borrowing to be sourced through the central banks that have withheld the currency trading right to lend ((FXR (ζ, $) or the currency trading ownership right (FXR (α, $)), which facilitates immediate location and borrowing or purchasing of said currencies.

22. The system of claim 16, which further comprises a third networked group of computer systems for use by government regulatory agencies, and being interfaced with the infrastructure of said distributed communications network, and including client machines and server machines, for supporting communications between said data center and said third networked group of computer systems; and wherein said government regulatory agencies use said third networked group of computer systems to communicate with said data center via packet-based communications, for the purpose of overseeing said central banks and said currency borrowers and purchasers in said financial marketplace.

23. The system of claim 16, wherein central banks are able to withhold, prior to issuance or sale, or after restructuring, the individual currency trading right to lend ((FXR (ζ, $), so as to preclude borrowing and, thus, short-selling of said currencies, or the individual currency trading ownership right (FXR (α, $)), so as to preclude the excessive purchasing of said currencies.

24. The system of claim 16, wherein said central banks are able to restructure existing, outstanding currencies to withhold the individual currency trading right to lend ((FXR (ζ, $), so as to preclude borrowing and, thus, short-selling of their currencies, or to withhold the individual currency trading ownership right (FXR (α, $)), so as to preclude excessive purchasing or their currencies.

25. The system of claim 16, whereby a long-only (non-borrowable) currency is created by a central bank by permanently withholding the currency trading right to lend ((FXR (ζ, $) prior to the issuance/sale of a currency or after a currency's restructuring.

26. The system of claim 16, whereby a non-purchasable currency is created by a central bank by permanently withholding the currency trading ownership right ((FXR (α, $) prior to the issuance sale of a currency or after a currency's restructuring.
